(19) United States
(12) Patent Application Publication
(10) Pub. No.: US 2022/0023953 A1
(43) Pub. Date: Jan. 27, 2022

(54) MILLING TOOL HEAD ASSEMBLIES, REMOTE CONTROL SYSTEMS, AND PORTABLE MACHINE TOOLS INCLUDING THE SAME

(71) Applicant: Climax Portable Machine Tools, Inc., Newberg, OR (US)

(72) Inventors: Scott J. Thiel, Sherwood, OR (US); Daniel M. Jensen, Hillsboro, OR (US); Mark J. Owens, Sherwood, OR (US); Daniel J. Hanson, Portland, OR (US); Sydnee M. Hammond, Portland, OR (US)

(21) Appl. No.: 17/498,634

(22) Filed: Oct. 11, 2021

Related U.S. Application Data
(63) Continuation-in-part of application No. 16/837,890, filed on Apr. 1, 2020, now Pat. No. 11,167,359.
Application No. 16/837,890 is a continuation-in-part of application No. 17/143,996, filed on Jan. 7, 2021.
(60) Provisional application No. 62/835,995, filed on Apr. 18, 2019.
(60) Provisional application No. 62/959,445, filed on Jan. 10, 2020.

(51) Int. Cl. B23B 3/26; B23C 5/08; B23C 1/20; B23Q 9/00; B23Q 1/48

(52) U.S. Cl. CPC B23B 3/265; B23C 5/08; B23Q 1/48; B23Q 9/0014; B23C 1/20

(57) ABSTRACT

Milling tool head assemblies, remote control systems, and portable machine tools including the same. A milling tool head assembly comprises a milling tool head carriage, a milling tool head with a milling tool head base pivotally coupled to the milling tool head carriage, and a milling tool carrier operatively coupled to a cutting tool. The milling tool carrier is configured to travel along a primary tool path, and the milling tool carrier is slidingly coupled to the milling tool head base to define a secondary tool path of the milling tool carrier. In some examples, a portable machine tool comprises a machine frame, a rotating ring, a bridge, a facing tool head assembly, and a milling tool head assembly. In some examples, a remote control system for a portable machine tool comprises an operator pendant, a control tether, a pneumatic conditioning unit, and an auxiliary conditioning unit.

### RELATED APPLICATIONS

This application is a continuation-in-part of and claims priority to U.S. patent application Ser. No. 16/837,890, entitled “PORTABLE MACHINE TOOLS, KITS, AND METHODS FOR MACHINING ANNULAR AND STRAIGHT PLANAR SURFACES” filed on Apr. 1, 2020, which claims priority to U.S. Provisional Patent Application No. 62/835,995, entitled “METHODS AND KITS FOR MACHINING TUBE SHEETS OF SHELL-AND-TUBE HEAT EXCHANGERS” filed on Apr. 18, 2019, the disclosures of which are incorporated by reference. This application additionally is a continuation-in-part of and claims priority to U.S. patent application Ser. No. 17/143,996, entitled “LATHE GUARD SYSTEMS, REMOTE LATHE CONTROL SYSTEMS, AND PORTABLE LATHE ASSEMBLY KITS INCLUDING THE SAME” filed on Jan. 7, 2021, which claims priority to U.S. Provisional Patent Application No. 62/959,445, entitled “LATHE GUARD SYSTEMS, REMOTE LATHE CONTROL SYSTEMS, AND PORTABLE LATHE ASSEMBLY KITS INCLUDING THE SAME” filed on Jan. 10, 2020, the disclosures of which also are incorporated by reference.

### FIELD

The present disclosure relates to machining.

### BACKGROUND

Shell-and-tube heat exchangers comprise several tubes housed within a cylindrical shell. Some shell-and-tube heat exchangers comprise tube sheets at opposing ends of the tubes to fluidically seal the cylindrical shell and thus to prevent the shell-side fluid from entering the heat exchanger's opposing heads (also referred to as channels or bonnets), where the tube-side fluid is routed. Accordingly, the tube sheets have an annular gasket surface, whose surface finish is critical for maintaining a proper seal with the adjacent head. Tube sheets also comprise holes through which the tubes extend for fluid communication with the heads. The heads comprise partition plates (planar structures with straight edges) for segregating regions of the heads and controlling the flow of tube-side fluid therethrough. The tube sheets have corresponding linear grooves for receipt of the partition plates, with the finish of the grooves' surfaces being critical for a proper seal with the partition plates when the heat exchanger is assembled. In some shell-and-tube heat exchangers, all of the partition plates are parallel to each other, while in other shell-and-tube heat exchangers, partition plates may not all be parallel to each other, such as with at least one partition plate being perpendicular to one or more other partition plates. FIG. 1 depicts a tube sheet 10 having an annular gasket surface 12 and a single linear groove 14, FIG. 2 depicts a tube sheet 16 having an annular gasket surface 12 and two parallel linear grooves 14, and FIG. 3 depicts a tube sheet 18 having an annular gasket surface 12 and three linear grooves 14, one of which is perpendicular to the other two. In the examples of FIGS. 1 and 2, the annular gasket surface 12 is coplanar with the linear grooves 14, while in the example of FIG. 3, the linear grooves 14 are raised relative to the annular gasket surface 12.

When such shell-and-tube heat exchangers are rebuilt or otherwise serviced, the annular gasket surface and the groove(s) of the tube sheets often are refinished. Historically, to do so, a flange facer is first mounted to the tube sheet for refinishing the annular gasket surface. Then, the flange facer is unmounted, and a cantilever milling machine is subsequently mounted to the tube sheet and used to mill the grooves. However, because cantilever milling machines are limited in their range of motion, the cantilever milling machine typically must be unmounted and remounted in various positions to be able to mill all of the tube sheet's grooves, especially when there are grooves that are not parallel to each other. After the annular gasket surface and linear grooves are resurfaced, chamfers (indicated at 20 in FIGS. 1-3) at the intersection of the annular gasket surface and the linear grooves and/or at the intersection of two linear grooves are manually machined using a powered hand grinder and/or hand-filed with a rasp and/or file. The mounting and unmounting of the cantilever milling machine as well as the manual filing are very time consuming, and thus costly.

### SUMMARY

Milling tool head assemblies, remote control systems, and portable machine tools including the same are disclosed herein.

In some examples, a milling tool head assembly comprises a milling tool head carriage and a milling tool head that comprises a milling tool head base and a milling tool carrier. The milling tool head base is pivotally coupled to the milling tool head carriage, which may be configured to be operatively coupled to a track of a machine tool and to translate along the track to translate the milling tool head along the track. The milling tool carrier is configured to be operatively coupled to a cutting tool, which may be configured to machine a workpiece to which a bridge of the machine tool is operatively coupled. The milling tool carrier is configured to travel along a primary tool path relative to the workpiece, and the milling tool carrier is slidingly coupled to the milling tool head base to define a secondary tool path of the milling tool carrier relative to the workpiece. In some examples, a portable machine tool comprises a machine frame configured to be fixedly coupled to a workpiece to operatively support the portable machine tool on the workpiece, a rotating ring that is rotatingly coupled to the machine frame, a bridge that is coupled to the rotating ring, a facing tool head assembly, and a milling tool head assembly. The facing tool head assembly is configured to be selectively coupled to and decoupled from the bridge. When the facing tool head assembly is coupled to the bridge, the rotating ring is configured to be selectively rotated relative to the machine frame to rotate the facing tool head assembly to operatively machine an annular planar surface on the workpiece. The milling tool head assembly is configured to be selectively coupled to and decoupled from the bridge. When the milling tool head assembly is coupled to the bridge, the bridge is configured to selectively translate the milling tool head assembly along the bridge to operatively machine a linear planar surface on the workpiece. In some examples, a remote control system for a portable machine tool comprises an operator pendant, a control tether, a pneumatic conditioning unit, and an auxiliary conditioning unit. The operator pendant is configured to receive a user input from a human user and to generate a control signal for remote operation of a portable machine tool. The control tether extends from the operator pendant to convey the control signal to another component of the remote control system. The pneumatic conditioning unit is configured to receive and condition a pneumatic air source, and comprises a pneumatic air inlet configured to receive a pneumatic air flow. The pneumatic conditioning unit further comprises a main air supply outlet configured to supply at least a portion of the pneumatic air flow to another component of the remote control system and/or to the portable machine tool. The control signal comprises at least a portion of the pneumatic air flow. The auxiliary conditioning unit is configured to receive the pneumatic air flow from the pneumatic conditioning unit and to supply the pneumatic air flow to the portable machine tool at least partially based upon the user input received by the operator pendant.

### BRIEF DESCRIPTION OF THE DRAWINGS

FIG. 1 is an illustration of an example tube sheet having a single linear groove.

FIG. 2 is an illustration of an example tube sheet having two parallel linear grooves.

FIG. 3 is an illustration of an example tube sheet having three linear grooves, one of which is perpendicular to the other two.

FIG. 4 is a schematic diagram representing example portable machining kits according to the present disclosure.

FIG. 5 is a schematic diagram representing example portable machine tools according to the present disclosure.

FIG. 6 is a top front side isometric view of a first example portable machine tool according to the present disclosure with a facing tool head assembly installed and shown with an example tube sheet to be machined.

FIG. 7 is a fragmentary top side isometric cut-away view of a portion of the first example portable machine tool of FIG. 6.

FIG. 8 is a top front side isometric view of the first example portable machine tool of FIG. 6 with a milling tool head assembly installed and shown with the example tube sheet to be machined.

FIG. 9 is a fragmentary top front side isometric view of a portion of the first example portable machine tool of FIG. 6.

FIG. 10 is a fragmentary top front side isometric view of a portion of the first example portable machine tool of FIG. 6 with the milling tool head assembly installed.

FIG. 11 is a top front side isometric view of a second example portable machine tool according to the present disclosure with a milling tool head assembly installed.

FIG. 12 is a fragmentary top front side isometric view of a portion of the second example portable machine tool of FIG. 11 with the milling tool head assembly installed.

FIG. 13 is a fragmentary top plan view of a portion of the second example portable machine tool of FIG. 11 with the milling tool head assembly installed.

FIG. 14 is a rear side elevation view of the milling tool head assembly of the second example portable machine tool of FIG. 11.

FIG. 15 is an exploded top front side isometric view of the milling tool head assembly of the second example portable machine tool of FIG. 11.

FIG. 16 is a fragmentary top front side isometric view of a portion of the second example portable machine tool of FIG. 11 with a portion of the milling tool head assembly installed.

FIG. 17 is a schematic diagram representing an example of a remote control system according to the present disclosure.

FIG. 18 is a top front side isometric view of an example of an operator pendant of a remote control system according to the present disclosure.

FIG. 19 is a top front side isometric view of an example of a pneumatic conditioning unit of a remote control system according to the present disclosure.

FIG. 20 is another top front side isometric view of the pneumatic conditioning unit of FIG. 19.

FIG. 21 is a top front side isometric view of an example of an auxiliary conditioning unit of a remote control system according to the present disclosure.

FIG. 22 is another top front side isometric view of the auxiliary conditioning unit of FIG. 21.

FIG. 23 is a flowchart, schematically representing examples of methods according to the present disclosure.

### DESCRIPTION

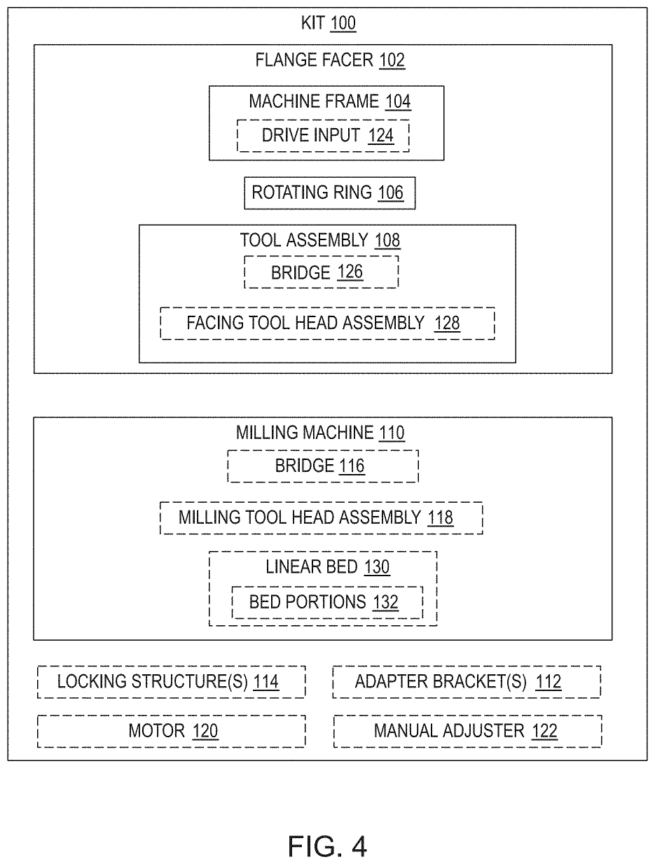

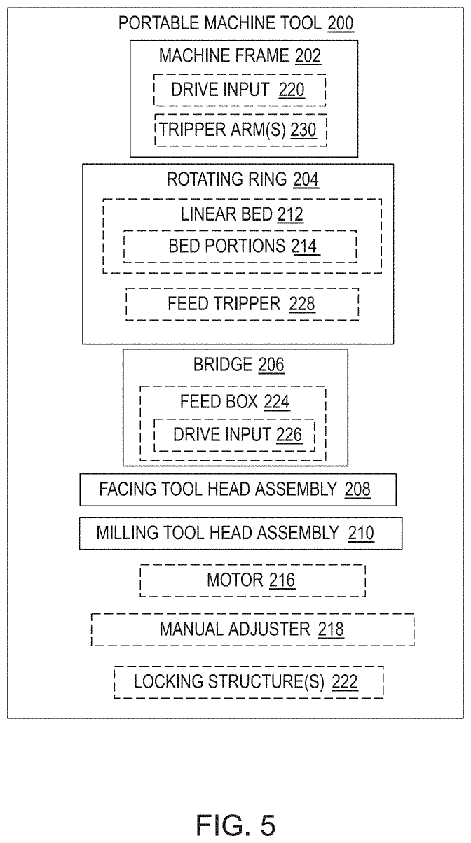

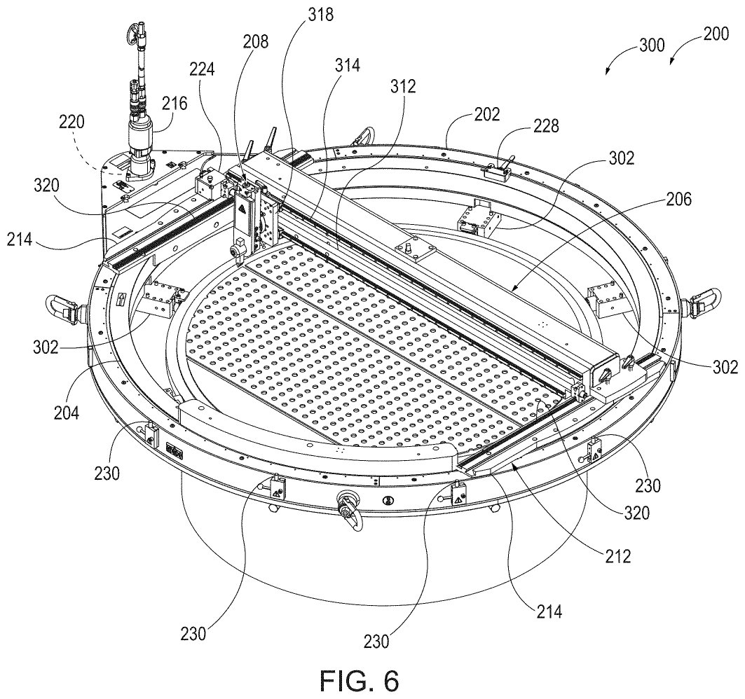

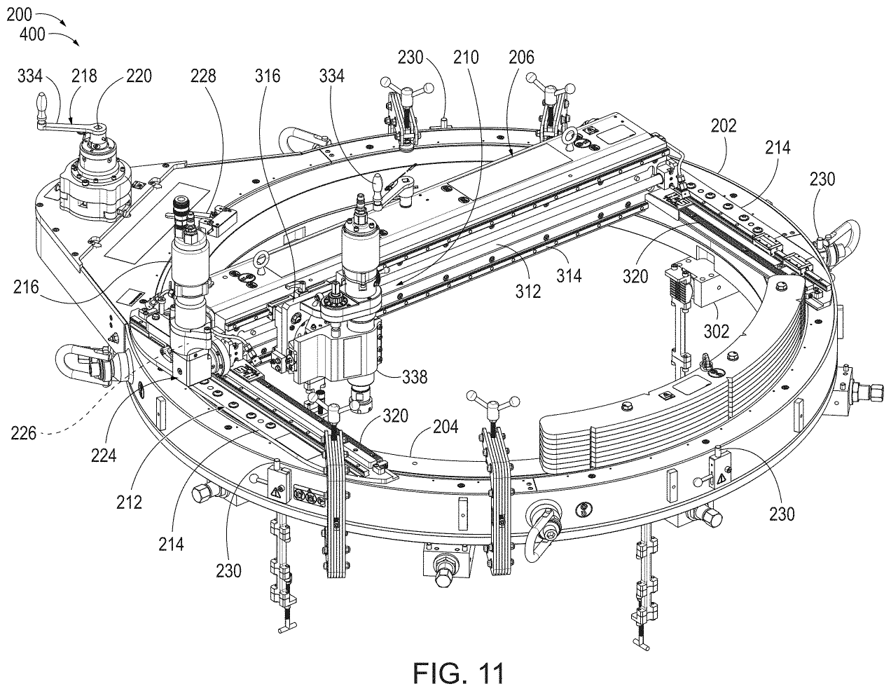

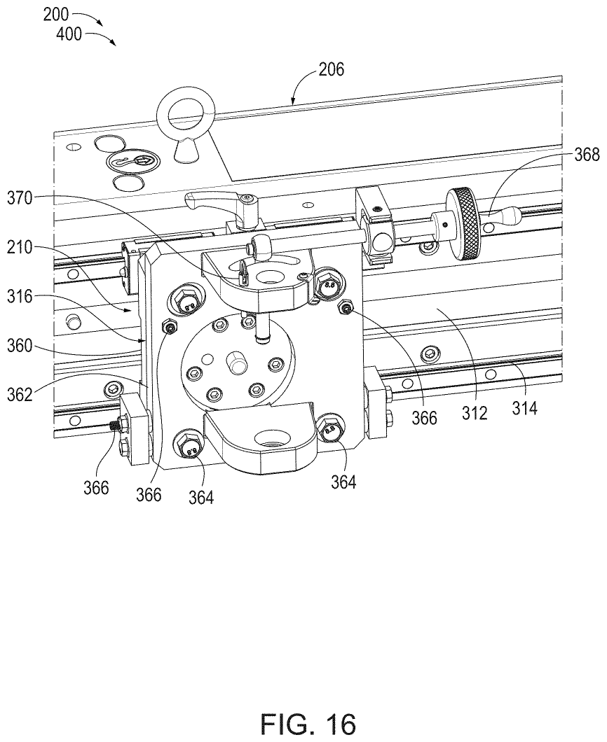

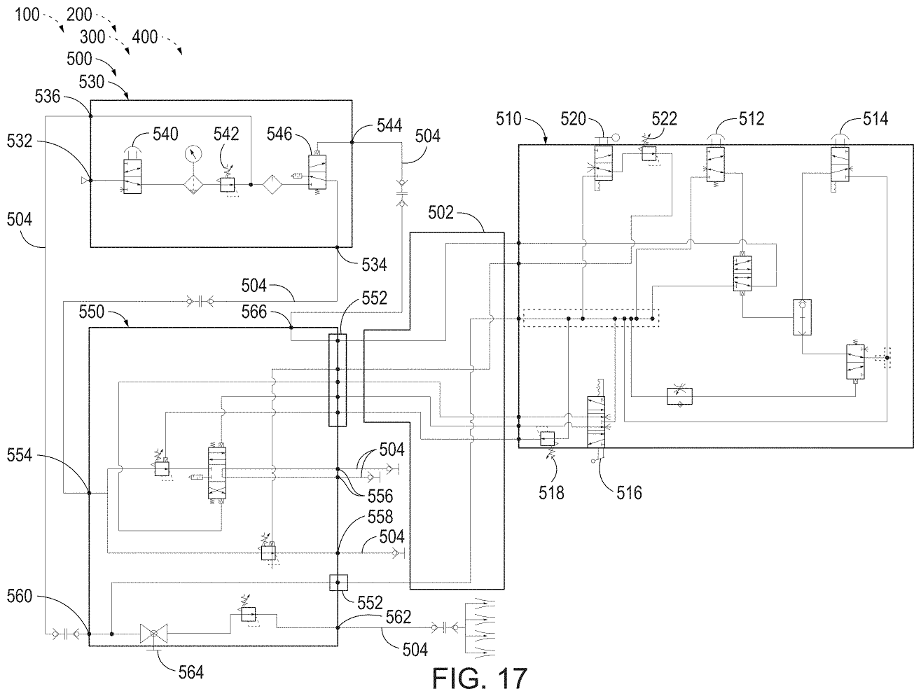

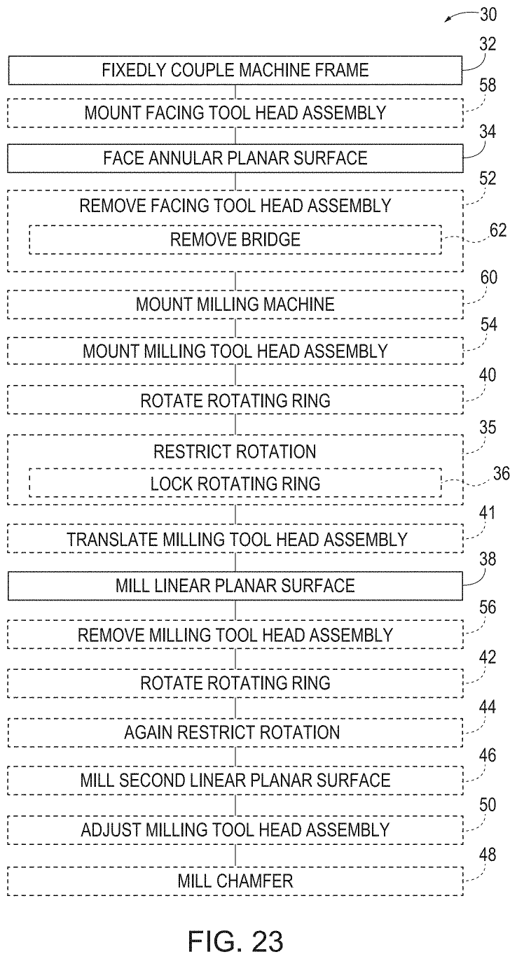

Methods 30, portable machining kits 100, portable machine tools 200, milling tool head assemblies 210 for machining annular and linear planar surfaces on a workpiece, and remote control systems 500 are disclosed. FIG. 23 schematically provides a flowchart that represents examples of methods 30, FIG. 4 schematically represents portable machining kits 100, FIG. 5 schematically represents portable machine tools 200, FIGS. 6-10 illustrate a first example portable machine tool 300, FIGS. 11-16 illustrate a second example portable machine tool 400, and FIGS. 17-22 illustrate an example of a remote control system 500. Methods 30 may be performed by portable machining kits 100 and/or portable machine tools 200 (e.g., by first example portable machine tool 300 and/or by second example portable machine tool 400), and conversely, portable machining kits 100 and portable machine tools 200 may be configured to perform example methods 30. In general, in FIGS. 5-6 and 23, elements that are likely to be included are illustrated in solid lines, while elements that may be optional to a given example or otherwise correspond to a specific example are illustrated in dashed lines. However, elements that are shown in solid lines are not essential to all examples, and an element shown in solid lines may be omitted from a given example without departing from the scope of the present disclosure. Moreover, the steps of methods 30 are not required to be performed in the order illustrated in FIG. 23, and the steps may be performed in any suitable, or operable, order. That said, in some examples of methods 30, an order of steps may be required, as discussed in detail herein with respect to such example methods 30.

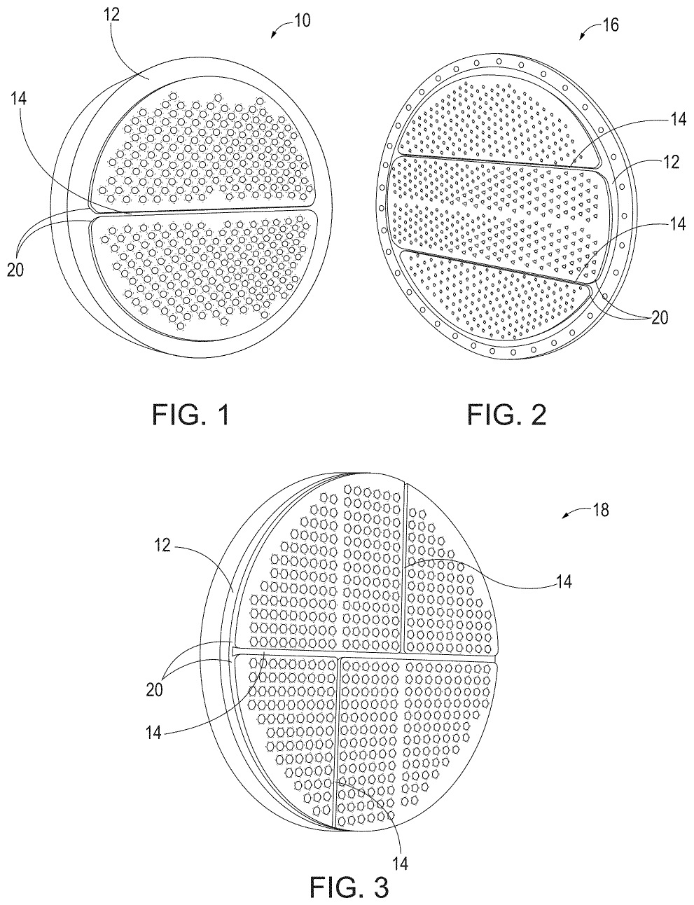

FIG. 4 schematically represents examples of portable machining kits 100 for machining an annular planar surface (such as the annular gasket surfaces 12 illustrated in FIGS. 1-3) and a linear planar surface (such as the linear grooves 14 illustrated in FIGS. 1-3) on a workpiece (such as the tube sheet 10 of FIG. 1, the tube sheet 16 of FIG. 2, and/or the tube sheet 18 of FIG. 3). As illustrated, such portable machining kits 100 comprise at least a flange facer 102 and a milling machine 110. The flange facer 102 comprises at least a machine frame 104, a rotating ring 106 that is rotatingly coupled to the machine frame 104, and a flange facer tool assembly 108 that is removably coupled to the rotating ring 106. In some examples, the flange facer tool assembly 108 of the flange facer 102 comprises at least a flange facer bridge 126 and a facing tool head assembly 128 operably coupled to the flange facer bridge 126 for facing annular planar surfaces. The milling machine 110 is configured to be operatively mounted to the rotating ring 106 of the flange facer 102, for example, after first removing the flange facer tool assembly 108 (e.g., a bridge and a facing tool head assembly) from the rotating ring 106. Examples of suitable flange facers comprise (but are not limited to) the H & S TOOL SPEED FACER series by Climax Portable Machine Tools, Inc. of Newberg, Oreg., and competitive products, and examples of suitable milling machines comprise (but are not limited to) the PM4200, LM5200, and LM6200 mills by Climax Portable Machine Tools, Inc. and competitive products.

In examples of portable machining kits 100, and as schematically represented in FIG. 4, the milling machine 110 comprises a milling machine bridge 116 and a milling tool head assembly 118 that is operably coupled to the milling machine bridge 116 for milling a linear planar surface on the workpiece. In some such examples, the milling tool head assembly 118 is configured to be selectively adjusted to adjust an angle of a secondary tool path of the milling tool head assembly 118 relative to the milling machine bridge 116, such as in the manner discussed below in connection with milling tool head assembly 210 of portable machine tools 200. In some examples, and as described in more detail herein, the milling tool head assembly 118 is configured to be utilized in conjunction with a cutting tool 352 that is configured to machine and/or mill the linear planar surface on the workpiece. In some examples, the milling tool head assembly 118 comprises the cutting tool 352.

Because the milling machine 110 is configured to be operatively mounted to the rotating ring 106 of the flange facer 102, the milling machine 110 when mounted to the rotating ring 106 may be selectively rotated relative to the machine frame 104 of the flange facer 102 to operably align the milling tool head assembly 118 of the milling machine 110 for milling a linear planar surface on the workpiece, such as discussed in detail above with respect to methods 30.

As schematically represented in FIG. 4, some portable machining kits 100 further comprise one or more adapter brackets 112 that are configured to operatively mount the milling machine 110 to the rotating ring 106 of the flange facer 102. In other words, in some examples, the milling machine 110 may not be configured to be directly mounted to, or engaged with, the rotating ring 106 of the flange facer 102, and instead one or more adapter brackets 112 may be provided as an interface between the milling machine 110 and the rotating ring 106. When provided, adapter brackets 112 provide structure for operably coupling the adapter brackets between the rotating ring 106 of the flange facer 102 and the milling machine 110. For example, adapter brackets 112 may have holes, slots, or other bores configured to be aligned with corresponding holes in the rotating ring 106 for receipt of fasteners therethrough, as well as holes, slots or other bores configured to be aligned with corresponding holes in the milling machine 110 for receipt of fasteners therethrough.

Some portable machining kits 100 further comprise at least one locking structure 114 that is configured to selectively lock the rotating ring 106 to the machine frame 104 to restrict rotation of the rotating ring 106 relative to the machine frame 104. Accordingly, the rotating ring 106 may be selectively (e.g., by a user, such as a human user) and temporarily restricted from rotating relative to the machine frame 104 for use of the milling machine 110 to mill a linear planar surface when the milling machine 110 is operatively coupled to the rotating ring 106. Any suitable locking structures 114 may be comprised in a portable machining kit 100 or be integral to a flange facer 102 thereof, illustrative, non-exclusive examples of which comprise an integral clamping mechanism of the flange facer, a locking pin or other structure and corresponding holes that, when aligned, extend at least partially through the rotating ring 106 and the machine frame 104, such that when the locking pin or other structure is operably positioned within the aligned holes, the rotating ring 106 is prevented from rotating relative to the machine frame 104. When provided, a locking structure 114 additionally may counteract milling loads to reduce loading on the bearings of the rotating ring 106. Additionally or alternatively, the static torque of a motor of the flange facer 102 may be used to restrict rotation of the rotating ring 106 relative to the machine frame 104 during a milling operation.

The rotating ring 106 of the flange facer 102 may be operatively and rotatingly coupled to the machine frame 104 using any suitable mechanism. For example, one or more of pulleys, belts, chains, gears, and assemblies thereof may be incorporated into a flange facer 102 to provide for rotational movement of the rotating ring 106 relative to the machine frame 104.

In some examples of portable machining kits 100, the milling machine bridge 116 is configured to be selectively translated relative to the rotating ring 106 of the flange facer 102 when the milling machine 110 is operatively coupled to the rotating ring 106. Accordingly, the milling machine bridge 116, and thus the milling tool head assembly 118, may be selectively positioned for operative milling of a linear planar surface on the workpiece. For example, some milling machines 110 further comprise a linear bed 130, along which the milling machine bridge 116 is configured to be selectively positioned, such as to align the milling tool head assembly 118 with respect to a workpiece for milling a linear planar surface thereof. When the milling machine 110 is a gantry milling machine, the linear bed 130 comprises two spaced-apart bed portions 132. In some such examples, it is the bed portions 132 that are configured to be operatively coupled to the rotating ring 106, either directly or via adapter brackets 112.

As schematically represented in FIG. 4, some portable machining kits 100 further comprise a motor 120 that is configured to be selectively coupled to the flange facer 102 for operation thereof and to be selectively coupled to the milling machine 110 for operation thereof. In other words, some portable machining kits 100 comprise a common (e.g., a single) motor 120 that is configured to be selectively coupled to each of the flange facer 102 and the milling machine 110 in turn. When coupled to the flange facer 102, the motor 120 operatively rotates the rotating ring 106, and thus the flange facer tool assembly 108, relative to the machine frame 104 for facing an annular planar surface. When coupled to the milling machine 110, the motor 120 operatively translates the milling tool head assembly 118 along the milling machine bridge 116 for milling a linear planar surface. In some examples, the same motor 120 also rotates the cutting tool 352 of the milling tool head assembly 118, while in other examples, a separate motor is used to rotate the cutting tool 352 of the milling tool head assembly 118.

As schematically represented in FIG. 4, some portable machining kits 100 further comprise a manual adjuster 122 that is configured to selectively adjust an angular orientation (e.g., a rotational position) of the rotating ring 106 relative to the machine frame 104. Accordingly, when the milling machine 110 is operatively coupled to the rotating ring 106, a user may manually adjust the angular orientation of the milling machine to properly align the milling tool head assembly 118 with the workpiece for milling a linear planar surface thereon. In some such examples, the machine frame 104 comprises a drive input 124 that is configured to be selectively coupled to and decoupled from the motor 120 for operation of the flange facer 102, and the manual adjuster 122 is configured to be selectively coupled to and decoupled from the drive input 124 when the motor is not coupled to the drive input 124. In other words, such as discussed herein with respect to example methods 30, following a facing operation and prior to a milling operation, the motor 120 may be removed from the drive input 124, the manual adjuster 122 may be coupled to the drive input 124, and a user may utilize the drive input 124 to manually rotate the rotating ring 106 to properly align the milling tool head assembly 118 with the workpiece for milling a linear planar surface thereon. As an illustrative, non-exclusive example, the manual adjuster 122 may comprise such structures as a hand crank 334 and/or a gear box operatively coupled to the hand crank, and with the gear box being geared to provide a desired gear ratio from input by the hand crank 334 to output by the rotating ring 106.

Turning now to FIG. 5, portable machine tools 200 for machining annular planar surfaces and linear planar surfaces on a workpiece are schematically represented. Portable machine tools 200 additionally or alternatively may be described as combination flange facer and milling machines. As schematically represented in FIG. 5, portable machine tools 200 typically comprise at least a machine frame 202 that is configured to be fixedly coupled to a workpiece to operatively support the portable machine tool 200 on the workpiece, a rotating ring 204 that is rotatingly coupled to the machine frame 202, a bridge 206 that is coupled to the rotating ring, a facing tool head assembly 208 that is configured to be selectively coupled to and decoupled from the bridge 206, and a milling tool head assembly 210 that also is configured to be selectively coupled to and decoupled from the bridge 206. The rotating ring 204 is configured to be selectively rotated relative to the machine frame 202 to rotate the facing tool head assembly 208 to operatively machine an annular planar surface on the workpiece when the facing tool head assembly 208 is coupled to the bridge 206. The rotating ring 204 may be rotatingly coupled to the machine frame 202 in any suitable and operative manner, including, for example, via one or more of gears, belts, chains, pulleys, and assemblies thereof.

When the facing tool head assembly 208 is coupled to the bridge 206, the portable machine tool 200 functions as a flange facer, similar to a flange facer 102 of a portable machining kit 100, discussed above. The bridge 206 is configured to selectively translate the milling tool head assembly 210 along the bridge 206 to operatively machine a linear planar surface on the workpiece when the milling tool head assembly is coupled to the bridge. In other words, when the milling tool head assembly 210 is coupled to the bridge 206, the portable machine tool 200 functions as a milling machine, similar to a milling machine 110 of a portable machining kit 100, discussed above. More specifically, when the portable machine tool 200 functions as a milling machine, the portable machine tool 200 is operable to translate the milling tool head assembly 210 along a length of the bridge 206, and thus to translate the milling tool head assembly (and/or the cutting tool 352 operatively coupled thereto) along a primary tool path that extends parallel to the bridge 206. In some examples, and as described in more detail herein, when the portable machine tool 200 functions as a milling machine, the portable machine tool 200 and/or the milling tool head assembly 210 also is operable to selectively translate at least a portion of the milling tool head assembly 210 (and/or the cutting tool 253 operatively coupled thereto) along a secondary tool path that is angled relative to the primary tool path and/or relative to the length of the bridge 206. By contrast, a typical flange facer, such as a flange facer 102 of a portable machining kit 100, is not configured to operatively translate a milling tool head assembly along a bridge thereof for milling a linear planar surface on a workpiece. Accordingly, a portable machine tool 200 additionally or alternatively may be described as a modified flange facer or as a flange facer with milling functionality.

In some examples, the rotating ring 204 has a feed tripper 228, the machine frame 202 has one or more tripper arms 230, and the bridge 206 has a feed box 224 operatively coupled to the feed tripper 228 (e.g., via a Bowden cable) and to the facing tool head assembly 208, with the feed tripper 228, the tripper arm 230, and the feed box 224 collectively defining a feed mechanism for incremental translation of a tool head assembly along the bridge 206. In particular, in such examples, the feed tripper 228 is operatively coupled to the facing tool head assembly 208 (e.g., via a feed screw supported by the bridge 206) such that the feed tripper 228 is operable to translate the facing tool head assembly 208 along a length of the bridge 206. Accordingly, when a portable machine tool 200 is configured to face an annular planar surface (i.e., with the facing tool head assembly 208 installed on the bridge 206), as the rotating ring 204 rotates, periodic engagement between the feed tripper 228 and each tripper arm 230 will cause the feed box 224 to operatively and incrementally translate the facing tool head assembly 208 along the bridge 206.

The bridge 206 of portable machine tools 200 therefore serves not only to operatively position the facing tool head assembly 208 relative to a workpiece for facing an annular planar surface thereof, but also to operatively position and/or translate the milling tool head assembly 210 relative to a workpiece for milling a linear planar surface thereof. In some examples, the bridge 206 may be described as extending across, spanning, or dissecting the rotating ring 204. Because the bridge 206 carries and operatively translates the milling tool head assembly 210 when it is coupled to the bridge 206, the bridge additionally or alternatively may be described as a ram or a boom of portable machine tools 200.

In some examples, and as schematically represented in FIG. 5, the rotating ring 204 comprises a linear bed 212, and the bridge 206 is configured to be selectively translated along a length of the linear bed 212. In other words, a linear position of the bridge 206 relative to the rotating ring 204 may be adjusted by selectively translating the bridge 206 along the length of the linear bed 212. Specifically, in such examples, the linear bed 212 extends along a translation direction along which the bridge 206 is configured to translate (such as the Y-axis 246 described herein). However, such descriptions are not intended to require or imply that the linear bed 212 itself has a greater length along the translation direction relative to another linear dimension of the linear bed. In some such examples, the linear bed 212 comprises two spaced-apart bed portions 214, and the bridge 206 extends between the two spaced-apart bed portions 214, such as in a gantry configuration. In contrast, on typical flange facers, the bridge, or functionally equivalent structure thereof that carries a facing tool head assembly, is fixed relative to the rotating ring and is not configured to be adjusted.

In some examples, the rotating ring 204 is configured to be selectively restricted from rotating relative to the machine frame 202 for operation of the milling tool head assembly 210 when the milling tool head assembly 210 is coupled to the bridge 206. In some such examples, and as schematically represented in FIG. 5, the portable machine tool 200 further comprises one or more locking structures 222 that are configured to selectively lock the rotating ring 204 to the machine frame 202 to restrict rotation of the rotating ring 204 relative to the machine frame 202. Accordingly, the rotating ring 204 may be selectively (e.g., by a user) and temporarily restricted from rotating relative to the machine frame 202 when the milling tool head assembly 210 is coupled to the bridge 206 for milling a linear planar surface. Any suitable locking structures 222 may be comprised in a portable machine tool 200, and in some examples may be integral to one or both of the machine frame 202 or the rotating ring 204. Illustrative, non-exclusive examples of suitable locking structures 222 comprise an integral clamping mechanism of the machine frame 202, a locking pin or other structure and corresponding holes that, when aligned, extend at least partially through the rotating ring 204 and the machine frame 202, such that when the locking pin or other structure is operably positioned within the aligned holes, the rotating ring 204 is prevented from rotating relative to the machine frame 202. When provided, a locking structure 222 additionally may counteract milling loads to reduce loading on the bearings of the rotating ring 204. Additionally or alternatively, the static torque, or resistance, of a motor and/or associated gear box or gearing may be sufficient to restrict rotation of the rotating ring 204 relative to the machine frame 202.

As used herein, the term “restrict,” as used to describe a mechanism or action in opposition to a process or outcome, is intended to indicate that the mechanism or action operates to at least substantially, and optionally fully, diminish, block, and/or preclude the process or outcome from proceeding and/or being completed. As examples, the use of the term “restrict,” such as in describing a mechanism as restricting the rotation of the rotating ring relative to the frame, is intended to indicate that the mechanism selectively prevents, impedes, blocks, obstructs, and/or otherwise substantially limits an ability of the rotating ring to rotate relative to the frame without damage to the portable machine tool. As used herein, the term “prevent,” as used to describe a mechanism or action in opposition to a process or outcome, is intended to indicate that the mechanism or action operates to fully block and/or preclude the process or outcome from proceeding and/or being completed during operative use of the structures and components according to the present disclosure. Stated differently, as used herein, the term “prevent” is not intended to indicate that the mechanism or action will fully block and/or preclude the process or outcome from proceeding and/or being completed in all possible uses, but rather is intended to indicate that the process or outcome is prevented at least when the structures and components disclosed herein are utilized in a manner consistent with the present disclosure.

In some examples of portable machine tools 200, and as described in more detail herein, the milling tool head assembly 210 is configured to be selectively adjusted to adjust an angle of the secondary tool path of the milling tool head assembly 210 relative to the bridge 206 when the milling tool head assembly 210 is coupled to the bridge 206. Accordingly, in such examples, a milling operation may be performed along a path that is not parallel to the bridge 206. This secondary tool path may be used to machine chamfers between two linear planar surfaces and/or between a linear planar surface and an annular planar surface, as discussed herein in connection with example methods 30.

As schematically represented in FIG. 5, some portable machine tools 200 further comprise a motor 216. The motor 216 is configured to be selectively coupled to and decoupled from the machine frame 202. In particular, the motor 216 is configured to selectively rotate the rotating ring 204 relative to the machine frame 202 when the motor 216 is coupled to the machine frame 202 for facing annular planar surfaces on a workpiece. The motor 216 also is configured to be selectively coupled to and decoupled from the bridge 206. In particular, the motor 216 is configured to selectively translate the milling tool head assembly 210 along the bridge 206 when the motor 216 is operatively coupled to the bridge 206 for milling linear planar surfaces on a workpiece. In other words, and similar to the motor 120 of portable machining kits 100, a single motor 216 may be provided as part of a portable machine tool 200. When coupled to the machine frame 202, the motor 216 operatively rotates the rotating ring 204, and thus the bridge 206 and the facing tool head assembly 208 when coupled thereto, relative to the machine frame 202 for facing an annular planar surface. When coupled to the bridge 206, the motor 216 operatively translates the milling tool head assembly 210 along the bridge 206 along the primary tool path for milling a linear planar surface. In some examples, the same motor 216 also rotates the cutting tool 352 of the milling tool head assembly 210 to perform a milling operation, while in other examples, a separate motor is used to rotate the cutting tool of the milling tool head assembly 210.

As schematically represented in FIG. 5, some examples of portable machine tools 200 further comprise a manual adjuster 218 that is configured to selectively adjust an angular orientation (e.g., a rotational position) of the rotating ring 204 relative to the machine frame 202. Accordingly, a user may manually adjust the angular orientation of the rotating ring 204, and thus also of the bridge 206, to properly align the milling tool head assembly 210 with the workpiece for milling a linear planar surface thereon, when the milling tool head assembly 210 is coupled to the bridge 206. In particular, in some such examples, the manual adjuster 218 may be utilized to selectively rotate the rotating ring 204 such that the bridge 206 is at least substantially parallel to a length of the linear planar surface to be milled upon the workpiece. In some such examples, the machine frame 202 comprises a drive input 220 that is configured to be operatively and selectively coupled to the motor 216 for selective rotation of the rotating ring 204 relative to the machine frame 202, and the manual adjuster 218 is configured to be operatively and selectively coupled to and decoupled from the drive input 220 for manual adjustment of the angular orientation of the rotating ring 204 relative to the machine frame 202. In other words, such as discussed herein with respect to example methods 30, following a facing operation and prior to a milling operation, the motor 216 may be removed from the drive input 220, the manual adjuster 218 may be coupled to the drive input 220, and a user may utilize the manual adjuster 218 to manually rotate the rotating ring 204 to properly align the milling tool head assembly 210 with the workpiece for milling a linear planar surface thereon. As an illustrative, non-exclusive example, the manual adjuster 218 may comprise such structures as a hand crank 334 and/or a gear box coupled to the hand crank, and with the gear box being geared to provide a desired gear ratio from input by the hand crank to output by the rotating ring 204. As a more specific example, FIG. 11 illustrates an example in which the second example portable machine tool 400 comprises manual adjuster 218 operative coupled to machine frame 202 and in which manual adjuster 218 comprises a hand crank 334.

Additionally or alternatively, in some examples, and as discussed, the bridge 206 may comprise a feed box 224, which in turn may comprise a drive input 226 that is configured to be operatively and selectively coupled to the motor 216 for selective translation of a tool head assembly along the bridge 206. In some such examples, the manual adjuster 218 is configured to be operatively and selectively coupled to and decoupled from the drive input 226 for manual adjustment of a translational position of a tool head assembly along the bridge 206. For example, when the facing tool head assembly 208 is operatively coupled to the bridge, the manual adjuster 218 may be used to manually position and/or align the facing tool head assembly relative to the workpiece for facing an annular planar surface thereon.

Additionally or alternatively, in some examples, the feed box 224 comprises a manual adjustment feature that is configured to provide selective translation of a tool head assembly along the bridge 206, such as manual adjuster 218 described above.

FIGS. 6-16 illustrate more specific examples of portable machine tool 200 and/or of components thereof. Specifically, FIGS. 6-10 illustrate aspects of a first example portable machine tool 300, while FIGS. 11-16 illustrate aspects of a second example portable machine tool 400, each of which is an example of portable machine tool 200. Where appropriate, the reference numerals from the schematic illustration of FIG. 4 are used to designate corresponding parts of first example portable machine tool 300 of FIGS. 6-10 and/or of second example portable machine tool 400 of FIGS. 11-16; however, the examples of FIGS. 6-16 are non-exclusive and do not limit portable machine tools 200 to the illustrated examples of first example portable machine tool 300 and/or second example portable machine tool 400. That is, portable machine tools 200 are not limited to the specific embodiments of first example portable machine tool 300 or of second example portable machine tool 400, and portable machine tools 200 may incorporate any number of the various aspects, configurations, characteristics, properties, etc. of portable machine tools 200 that are illustrated in and discussed with reference to the schematic representation of FIG. 5 and/or the embodiments of FIGS. 6-16, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to the example of FIGS. 6-16; however, it is within the scope of the present disclosure that the previously discussed features, variants, etc. may be utilized with the example of FIGS. 6-16.

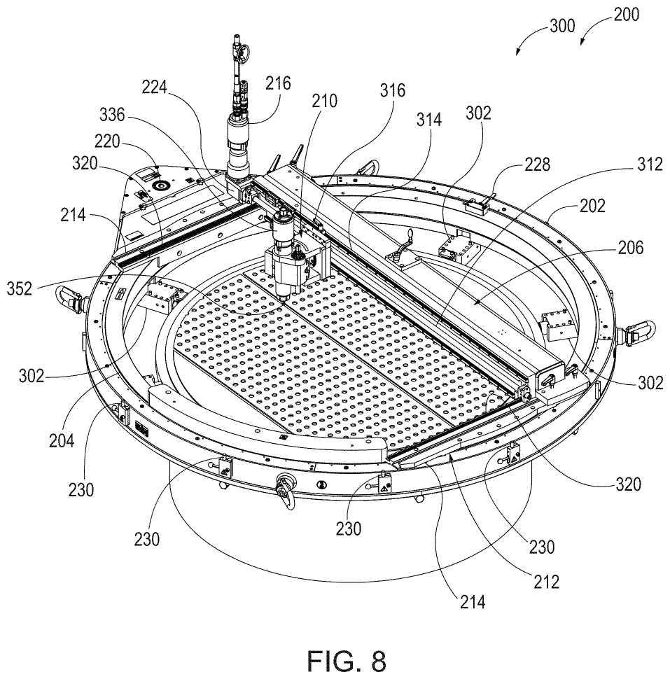

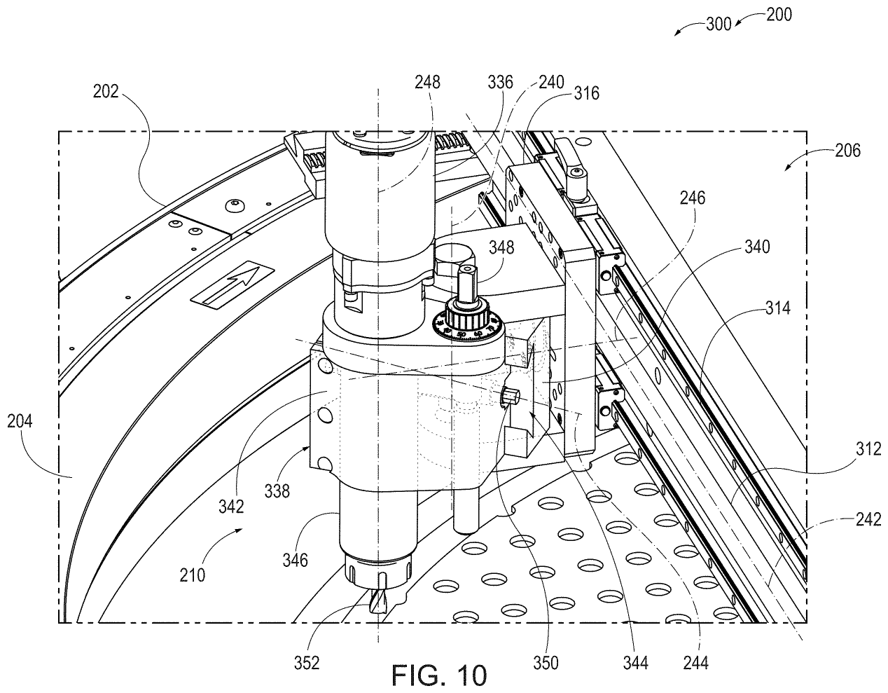

In each of FIGS. 6 and 8-10, first example portable machine tool 300 is illustrated with a non-exclusive example of a workpiece in the form of a tube sheet of a shell-and-tube heat exchanger. In particular, the illustrated example tube sheet comprises an annular gasket surface and two parallel linear grooves. That said, as discussed herein, portable machine tools 200, including first example portable machine tool 300, are not limited to being used with such workpieces. In FIG. 6, first example portable machine tool 300 is illustrated with its facing tool head assembly 208 coupled to its bridge 206, and thus is configured for facing an annular planar surface, such as the annular gasket surface of the illustrated example tube sheet. In FIGS. 8 and 10, first example portable machine tool 300 is illustrated with the milling tool head assembly 210 coupled to the bridge 206, and thus is configured for milling a linear planar surface, such as the linear grooves of the illustrated example tube sheet.

As illustrated in FIGS. 6 and 8-9, the machine frame 202 of first example portable machine tool 300 comprises a plurality of chuck foot assemblies 302 spaced around and extending radially inward from the machine frame 202 for operatively mounting the first example portable machine tool 300 to a workpiece.

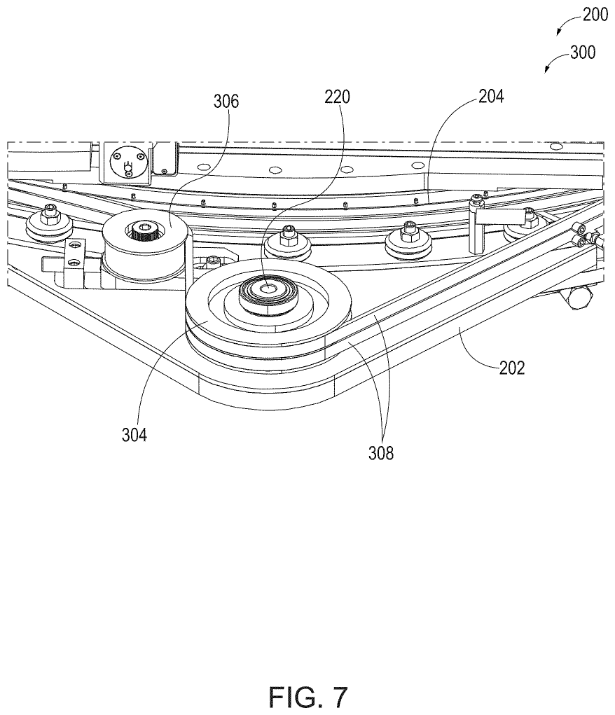

As seen with reference to FIGS. 6 and 8, first example portable machine tool 300 is an example of a portable machine tool 200 that comprises a common (e.g., a single) motor 216 that is configured to be selectively coupled to either of the machine frame 202 (FIG. 6) and the bridge 206 (FIG. 8). When coupled to the machine frame 202, and more specifically to a drive input 220 thereof, the motor 216 provides for operative rotation of the rotating ring 204 relative to the machine frame 202, such as to face an annular planar surface of a workpiece when the facing tool head assembly 208 is operatively coupled to the bridge 206. With reference to the detailed view of FIG. 7, the machine frame 202 of first example portable machine tool 300 comprises a drive pulley 304 coupled to the drive input 220, an idler pulley 306, and a pair of belts 308 that transfers the rotational input of the drive pulley 304 to the rotating ring 204.

As illustrated in FIGS. 6 and 8, first example portable machine tool 300 also is an example of a portable machine tool 200 that comprises a feed mechanism that comprises tripper arms 230 on the machine frame 202, a feed tripper 228 on the rotating ring 204, and a feed box 224 on the bridge 206 that is operatively coupled to the feed tripper 228 via a Bowden cable (not illustrated in FIGS. 6 and 8). The bridge 206 comprises a feed screw 312 coupled to the feed box 224 and configured to rotate incrementally responsive to the feed tripper 228 being actuated. Feed screws additionally or alternatively may be described as lead screws and/or ball screws. The bridge 206 further comprises a track 314, to which a tool head assembly (e.g., the facing tool head assembly 208) is selectively coupled. The facing tool head assembly 208 comprises a facing tool head carriage 318 that engages with the track 314 for translation therealong, and the facing tool head assembly 208 is configured to engage with the feed screw 312, such that when the feed screw 312 rotates, the facing tool head assembly 208 translates along the bridge 206. Any suitable number of tripper arms may be utilized to control the feed rate at which the facing tool head assembly 208 translates along the bridge 206. In particular, because the engagement between the feed tripper 228 and each tripper arm 230 upon each rotation of the rotating ring 204 causes the facing tool head assembly 208 to incrementally translate along the bridge 206, this feed rate may be selectively varied (at a given rotational speed of the rotating ring) by varying the number of tripper arms that are operable to engage the feed tripper. As a more specific example, the portable machine tool 200 may be configured such that each tripper arm 230 may be selectively transitioned between an activated configuration, in which the tripper arm is positioned to engage the feed tripper 228, and a disabled configuration, in which the tripper arm is positioned (e.g., pivoted) to avoid engagement with the feed tripper.

When the motor 216 is coupled to the bridge 206, and more specifically to the feed box 224 thereof, the motor 216 provides for operative translation of the milling tool head assembly 210 along the bridge 206. More specifically, with reference to FIG. 8, the feed screw 312 is configured to rotate responsive to input from the motor 216 when operatively coupled to the feed box 224. The milling tool head assembly 210 comprises a milling tool head carriage 316 that engages with the track 314 for translation therealong, and the milling tool head assembly 210 is configured to engage with the feed screw 312, such that when the feed screw 312 rotates in a first direction, the milling tool head assembly 210 translates in a first direction, and when the feed screw 312 rotates in a second opposite direction, the milling tool head assembly 210 translates in a second opposite direction. In such examples, each of the first direction and the second direction may be described as representing examples and/or subsets of the primary tool path. Additionally or alternatively, each of the first direction and the second direction may be described as extending parallel to the primary tool path.

As illustrated in FIG. 8, first example portable machine tool 300 comprises a second motor 336 operatively coupled to the milling tool head assembly 210 for operation of a milling cutting tool. In particular, in this example, first example portable machine tool 300 comprises each of the motor 216 and the second motor 336 such that the motor 216 and the second motor 336 may be utilized simultaneously to concurrently translate the milling tool head assembly 210 along the primary tool path and to rotate the cutting tool 352, respectively. In such examples, the motor 216 and the second motor 336 may be the same and/or similar types of motors, such as motors that each are configured to be pneumatically driven, motors that are configured to produce the same and/or similar torque outputs, etc.

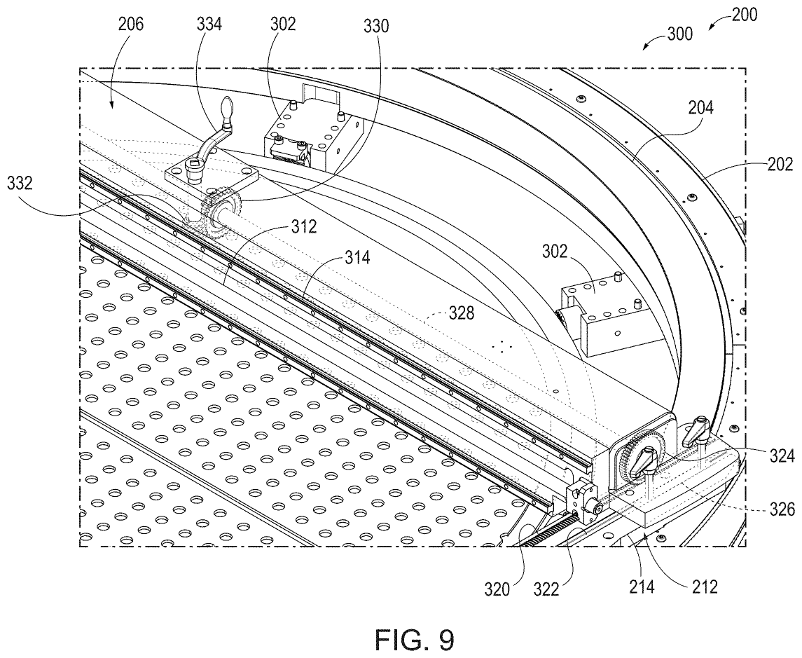

First example portable machine tool 300 is an example of a portable machine tool 200 in which the rotating ring 204 comprises a linear bed 212 that comprises two spaced-apart bed portions 214 for operative positioning of the bridge 206 along the linear bed 212. As perhaps best illustrated in FIG. 9, each bed portion 214 of first example portable machine tool 300 comprises a rack 320 and a T-slot 322, and the bridge 206 comprises corresponding pinion gears 324 and T-nuts 326 that engage with the rack 320 and the T-slot 322, respectively. The bridge 206 further comprises a rod 328 interconnecting the two pinion gears 324, a worm gear 330 carried by the rod 328, a worm 332 meshed with the worm gear 330, and a hand crank 334 coupled to the worm 332. Accordingly, rotation of the hand crank 334 causes the pinion gears 324 to rotate and ride along the racks 320 for translation of the bridge 206 along the linear bed 212. The T-nuts 326 are configured to be tightened against the bed portions 214 to lock the bridge 206 in a desired position along the linear bed 212.

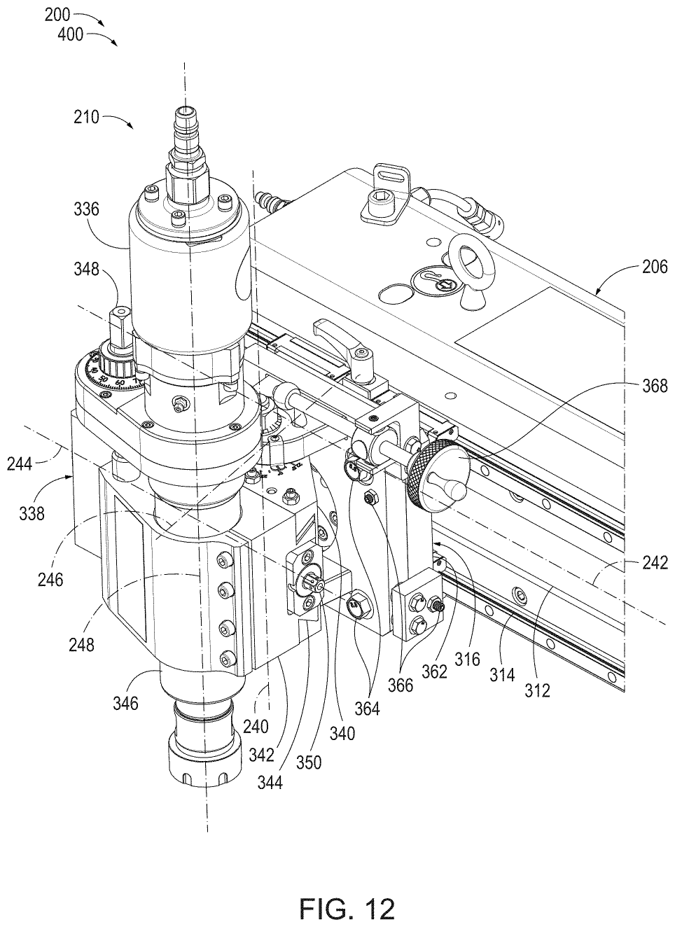

Turning briefly to FIGS. 11-16, FIG. 11 illustrates the second example portable machine tool 400, which is another example of portable machine tool 200 that comprises an example of the milling tool head assembly 210 disclosed herein, while FIGS. 12-16 illustrate features of the milling tool head assembly 210 of the second example portable machine tool 400. The second example portable machine tool 400 illustrated in FIG. 11 is substantially similar to the first example portable machine tool 300 illustrated in FIGS. 6-10, with the most notable exception being that the milling tool head assembly 210 of the second example portable machine tool 400 comprises certain features that are not present in the milling tool head assembly 210 of the first example portable machine tool 300, as described in more detail below. Nonetheless, the milling tool head assembly 210 of the first example portable machine tool 300 and the milling tool head assembly 210 of the second example portable machine tool 400 each are examples of milling tool head assemblies 210 according to the present disclosure. Accordingly, the following discussion of features of the milling tool head assembly 210 is presented with reference to each of FIG. 10 (illustrating the milling tool head assembly 210 of the first example portable machine tool 300) and FIGS. 12-16 (illustrating the milling tool head assembly 210 of the second example portable machine tool 400).

As illustrated in FIGS. 10 and 12-16, a milling tool head assembly 210 according to the present disclosure comprises a milling tool head carriage 316 and a milling tool head 338, which in turn comprises a milling tool head base 340 (illustrated in FIGS. 10 and 12-15) that is pivotally coupled to the milling tool head carriage 316. As discussed, the milling tool head carriage 316 is configured to be operatively coupled to the track 314 of the bridge 206 of the portable machine tool 200 and to translate along the track, thereby to translate the milling tool head 338 along the track. The milling tool head 338 additionally comprises a milling tool carrier 342 (illustrated in FIGS. 10 and 12-15) that is configured to be operatively coupled to the cutting tool 352 (illustrated in FIG. 10). In some examples, the milling tool head assembly 210 comprises the cutting tool 352.

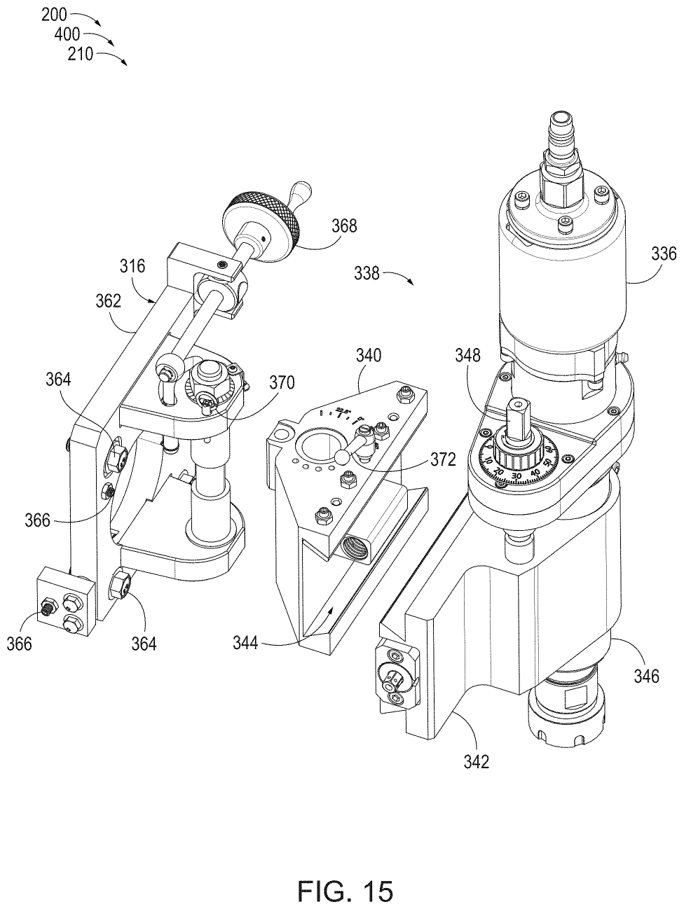

As discussed, the track 314 defines the primary tool path of the milling tool head assembly 210, which additionally or alternatively may be referred to as the primary tool path of the milling tool head 338, of the milling tool head base 340, of the milling tool carrier 342, and/or of the cutting tool 352. As further discussed, the milling tool head assembly 210 additionally is operable to selectively translate at least a portion of the milling tool head assembly along the secondary tool path, which may be angled relative to the primary tool path and/or relative to the length of the bridge 206. In particular, the milling tool carrier 342 is slidingly coupled to the milling tool head base 340 to define the secondary tool path. Stated differently, the milling tool head assembly 210 is configured such that the milling tool carrier 342 (and hence the cutting tool 352) may be selectively translated (e.g., slid) relative to the milling tool head base 340 to move the milling tool carrier 342 and the cutting tool 352 along the secondary tool path. In particular, in some examples, and as illustrated in FIGS. 10 and 12-15, the milling tool head assembly 210 comprises a tool head drive input shaft 350 that is configured to receive a rotary input (such as from the motor 216, from the second motor 336, and/or from the hand crank 334) to selectively translate the milling tool carrier 342 relative to the milling tool head base 340 along the secondary tool path and/or along the X2-axis 244 (illustrated in FIGS. 10 and 12-13). More specifically, in some examples, the tool head drive input shaft 350 comprises a feed screw that is meshed with a block (visible in FIG. 15) of the milling tool head base 340. Accordingly, when a user rotates the tool head drive input shaft 350, the milling tool carrier 342 translates relative to the milling tool head base 340 along a linear path that is defined by the sliding joint 344.

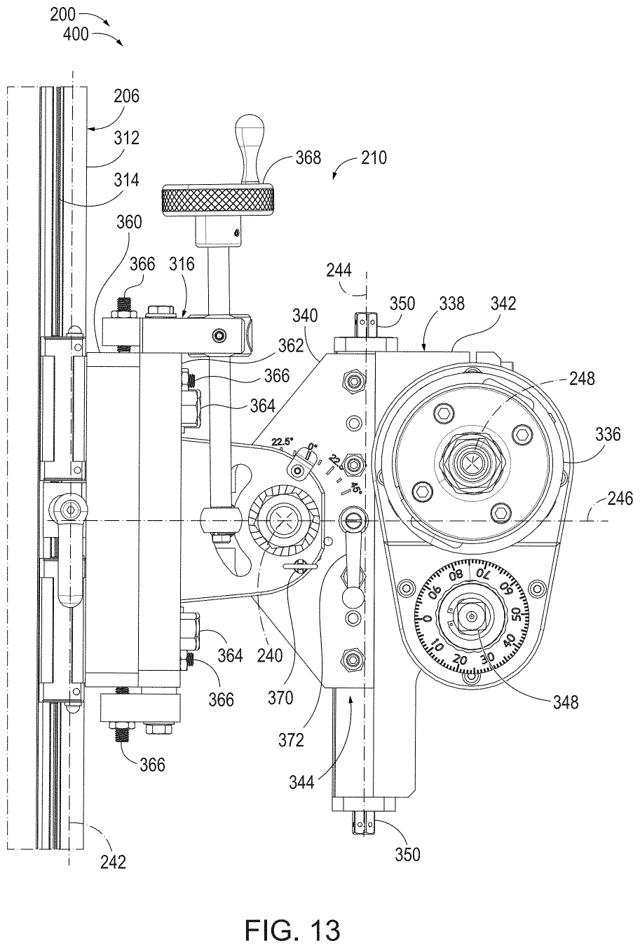

In some examples, and as illustrated in FIGS. 10 and 12-13, the milling tool carrier 342 is slidingly coupled to the milling tool head base 340 via a sliding joint 344, such as a dovetail joint. In particular, the sliding joint 344 may be configured to selectively permit the milling tool carrier 342 to translate relative to the milling tool head base 340 along the secondary tool path, and to restrict the milling tool carrier 342 from translating relative to the milling tool head base 340 along a direction at least substantially perpendicular to the secondary tool path. In some examples, the sliding joint 344 also is configured to selectively restrict the milling tool carrier 342 from rotating relative to the milling tool head base 340. Additionally or alternatively, in some examples, the sliding joint 344 is configured to selectively restrict the milling tool carrier 342 from translating relative to the milling tool head base 340. For example, when the portable machine tool 200 is operable to translate the milling tool head assembly 210 along the length of the bridge 206 (e.g., along the primary tool path), it may be desirable to restrict the milling tool carrier 342 from translating relative to the milling tool head base 340 along the secondary tool path. Accordingly, in some examples, and as illustrated in FIGS. 13-15, the milling tool head assembly 210 further comprises a milling tool carrier lock mechanism 372 that is configured to selectively engage each of the milling tool carrier 342 and the milling tool head base 340 to selectively restrict the milling tool carrier 342 from translating relative to the milling tool head base 340.

Because the milling tool head base 340 supports the milling tool carrier 342 and is pivotally coupled to the milling tool head carriage 316, the orientation of the secondary tool path (e.g., relative to the milling tool head carriage 316 and/or to the track 314) may be adjusted by selectively pivoting the milling tool carrier 342 relative to the milling tool head carriage 316, as described herein. As used herein, the secondary tool path may be described as being a secondary tool path of the milling tool head assembly 210, of the milling tool carrier 342, and/or of the cutting tool 352.

As illustrated in FIGS. 10 and 12-13, the primary tool path, the secondary tool path, and/or other aspects of the milling tool head assembly 210 may be understood with reference to one or more axes associated with the milling tool head assembly. For example, the primary tool path may be described as extending along a direction parallel to an X-axis 242, such as may be defined by the track 314. Additionally or alternatively, the secondary tool path may be described as extending along an X2-axis 244, such as may be defined by an orientation of the sliding joint 344. Additionally or alternatively, the milling tool head base 340 may be described as being configured to pivot relative to the milling tool head carriage 316 about a milling tool head pivot axis 240 to selectively adjust an angle between the X2-axis 244 and the X-axis 242. In some examples, and as illustrated in FIGS. 10 and 12-13, the milling tool head pivot axis 240 is at least substantially perpendicular to the X-axis 242 and/or to the X2-axis 244.

In some examples, and as illustrated in FIGS. 10 and 12-13, the milling tool head assembly 210 also may be described with reference to a Z-axis 248, such as may extend at least substantially parallel to the milling tool head pivot axis 240 and/or at least substantially perpendicular to the X-axis 242 and/or to the X2-axis 244. In particular, in some examples, and as illustrated in FIGS. 10 and 12-15, the milling tool head assembly 210 further comprises a cutting tool spindle 346 that extends through the milling tool carrier 342 along the Z-axis 248 and that is configured to support and/or rotate the cutting tool 352 (shown in FIG. 10) relative to the workpiece.

In some examples, and as illustrated in FIGS. 10 and 12-13, the milling tool head assembly 210 also may be described with reference to a Y-axis 246 that is perpendicular to each of the X-axis 242 and the Z-axis 248. In particular, in some examples, the Y-axis 246 corresponds to a direction along which the bridge 206 is configured to translate along the linear bed 212 of the portable machine tool 200.

In some examples, the cutting tool spindle 346 is configured to be selectively adjusted relative to the milling tool carrier 342 along the Z-axis 248. In this manner, the milling tool head 338 may be described as being configured for selectively adjustment of the cutting tool 352 along the Z-axis 248, such as to adjust a height and/or a depth of a the cutting tool 352 relative to the workpiece to mill the workpiece to a desired depth. In some such examples, and as illustrated in FIGS. 10 and 12-15, the milling tool head assembly 210 comprises a spindle adjustment input shaft 348 that is configured to receive a rotary input (such as from the motor 216, from the second motor 336, and/or from the hand crank 334) to selectively translate the cutting tool spindle 346 relative to the milling tool carrier 342 along the Z-axis 248. Additionally or alternatively, in some examples, the milling tool carrier 342 is configured to selectively clamp the cutting tool spindle 346 in a desired position along the Z-axis 248 for operation of the milling tool head assembly 210. In this manner, the clamping of the cutting tool spindle 346 by the milling tool carrier 342 may be described as a coarse adjustment of the position of the cutting tool 352, while the adjustment of the cutting tool spindle 346 via the spindle adjustment input shaft 348 may be described as a fine adjustment of the position of the cutting tool 352.

In some examples, the milling tool head carriage 316 also is configured to selectively adjust a position and/or orientation of the milling tool carrier 342 and/or the cutting tool 352, such as relative to at least a portion of the milling tool head carriage 316, the X-axis 242, the track 314, the bridge 206, and/or the workpiece. In particular, in some examples, the milling tool head carriage 316 is configured to selectively pivot the milling tool head 338 relative to at least a portion of the milling tool head carriage 316, the X-axis 242, the track 314, the bridge 206, and/or the workpiece about an axis that is at least substantially parallel to the X-axis 242, an axis that is at least substantially parallel to the Y-axis 246, an axis that is at least substantially parallel to the Z-axis 248, and/or an axis that is at least substantially parallel to the milling tool head pivot axis 240. In particular, such functionality corresponds to the example of the milling tool head assembly 210 of the second example portable machine tool 400 as illustrated in FIGS. 11-16. Such additional degrees of freedom may enable the user to more precisely align the primary tool path and/or the cutting tool path with the workpiece. In particular, in some examples, the portable machine tool may be mounted to the workpiece such that the X-axis 242 and/or the X2-axis 244 do not extend perfectly parallel to a surface of the workpiece to be machine. In such examples, adjusting the orientation of the milling tool head 338 relative to the bridge 206 as described herein may operate to ensure that the primary tool path and the secondary tool path extend sufficiently parallel to the workpiece.

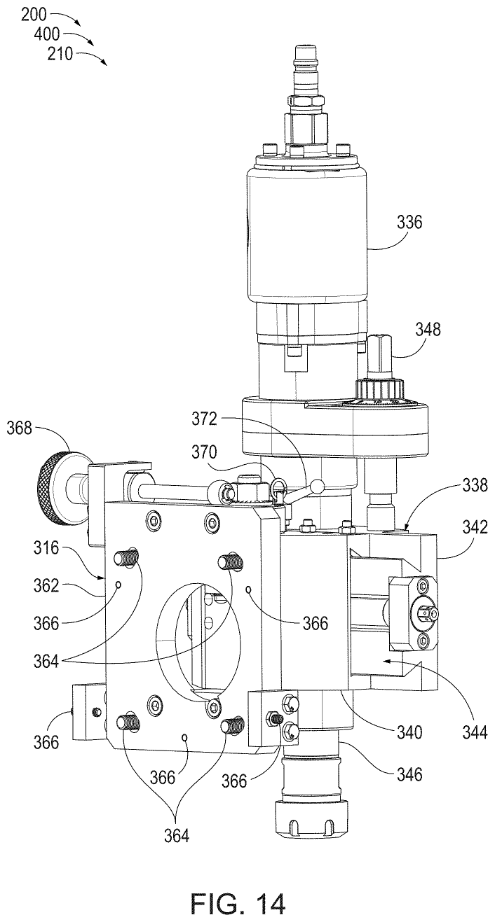

In some examples, and as illustrated in FIGS. 12-16, the bridge 206 comprises a carriage mount 360 that is operatively coupled to the track 314, and the milling tool head carriage 316 comprises a carriage base 362 that is configured to be adjustably and operatively coupled to the carriage mount 360. More specifically, in some such examples, and as shown in FIGS. 12-16, the milling tool head carriage 316 comprises one or more carriage fasteners 364 such that the carriage base 362 is configured to be operatively coupled to the carriage mount 360 at least partially via the carriage fasteners (364). In the example of FIGS. 12-15, the milling tool head carriage 316 comprises four carriage fasteners 364 in the form of bolts that extend through the carriage base 362 and that threadingly engage the carriage mount 360. In particular, in the example of FIGS. 12-16, and as perhaps best illustrated in FIG. 14, each carriage fastener 364 extends through a respective aperture in the carriage base 362 that is larger than the diameter of the carriage fastener. Thus, in this example, the orientation of the carriage base 362 relative to the carriage mount 360 may be selectively adjusted when each carriage fastener 364 is at least partially loosened, and the orientation of the carriage base 362 relative to the carriage mount 360 may be selectively fixed when each carriage fastener 364 is tightened. In this manner, the carriage fasteners 364 are configured to selectively and operatively retain the carriage base 362 in an orientation relative to the carriage mount 360 that is at least substantially fixed during operative use of the milling tool head assembly 210.

Additionally, in this example, and as illustrated in FIGS. 12-16, the milling tool head carriage 316 additionally comprises one or more carriage adjustment mechanisms 366 that are configured to define and/or adjust the orientation of the carriage base 362 relative to the carriage mount 360. Specifically, when present, the carriage adjustment mechanisms 366 are configured to engage each of the carriage mount 360 and the carriage base 362 to at least partially define the orientation of the carriage base 362 relative to the carriage mount 360. More specifically, in the example of FIGS. 12-16, each carriage adjustment mechanism 366 comprises and/or is a mechanical adjustment mechanism, such as a set screw that extends through the carriage base 362 and that engages (e.g., abuts) the carriage mount 360. Thus, in this example, the orientation of the carriage base 362 relative to the carriage mount 360 may be selectively adjusted by loosening each carriage fastener 364 to permit motion of the carriage base 362 relative to the carriage mount 360, adjusting each set screw of the carriage adjustment mechanisms 366 to bring the carriage base to a desired orientation, and tightening each carriage fastener 364 to fix the orientation of the carriage base 362. In this manner, the carriage adjustment mechanisms 366 may be configured to adjust the orientation of the carriage base 362 relative to the carriage mount 360 while the carriage fasteners 364 do not operatively retain the carriage base 362 in a fixed orientation relative to the carriage mount 360. The milling tool head carriage 316 may comprise any suitable number of carriage adjustment mechanisms 366, such as a number that corresponds to and/or enables pivoting of the carriage base 362 relative to the carriage mount 360 through one, two, or three degrees of freedom. In particular, such degrees of freedom may correspond to rotations about directions parallel to the X-axis 242, the Y-axis 246, and/or the Z-axis 248.

As discussed, the milling tool head assembly 210 is configured to enable adjustment of the secondary tool path, such as by adjusting the orientation of the X2-axis 244 illustrated in FIGS. 10 and 12-13). In particular, in some examples, the milling tool head base 340 is pivotally coupled to the carriage base 362 such that the milling tool head base 340 is configured to pivot relative to the carriage base 362 about the milling tool head pivot axis 240, thus adjusting the orientation of the X2-axis 244 relative to the carriage base 362. In some examples, such as the milling tool head assembly 210 of the first example portable machine tool 300, and with reference to FIG. 10, the milling tool head base 340 is configured to be pivoted relative to the carriage base 362 by selectively loosening a bolt that interconnects the milling tool head base 340 and the carriage base 362. In other examples, such as the milling tool head assembly 210 of the second example portable machine tool 400, and with reference to FIGS. 12-16, the milling tool head assembly 210 further comprises a secondary tool path angle adjustment mechanism 368 that is configured to selectively pivot the milling tool head base 340 relative to the carriage base 362 in order to at least partially define the orientation of the secondary tool path relative to the bridge 206 (shown in FIGS. 12-13 and 16). In particular, in the example of FIGS. 12-16, the secondary tool path angle adjustment mechanism 368 comprises a hand crank that is coupled to a threaded coupling to drive a rod that extends through a U-shaped slot in the carriage base 362 and that pivotally engages the milling tool head base 340. Additionally or alternatively, in some examples, such as in the example of FIGS. 12-16, the milling tool head assembly 210 further comprises a secondary tool path angle lock pin 370 that is configured to selectively restrict the milling tool head base 340 from pivoting relative to the carriage base 362. In particular, in the example of FIGS. 12-16, and as perhaps best understood with reference to FIG. 15, the secondary tool path angle lock pin 370 is configured to selectively engage the milling tool head base 340 and the carriage base 362 to selectively restrict the milling tool head base 340 from pivoting relative to the carriage base 362. More specifically, in this example, the secondary tool path angle lock pin extends through a hole defined in the carriage base 362 and is selectively received in any of a plurality of holes defined in the milling tool head base 340, each of which corresponds to a respective selected angle of the secondary tool path relative to the bridge 206 (shown in FIGS. 12-13 and 16).

As discussed herein, milling tool head assemblies 210 according to the present disclosure, such as the milling tool head assembly 210 of first example portable machine tool 300 or of second example portable machine tool 400, may be described as having at least five degrees of freedom or as providing at least five degrees of freedom for the associated cutting tool 352. More specifically, the milling tool head assembly is configured to be selectively translated along the track 314 of the bridge 206 (corresponding to motion along the X-axis 242), the bridge 206 is configured to be selectively translated along the linear bed 212 (corresponding to motion along the Y-axis 246), the cutting tool spindle 346 is configured to be selectively translated relative to the milling tool carrier 342 (corresponding to motion along the Z-axis 248), the milling tool head 338 is configured to be pivoted relative to the milling tool head carriage 316 (corresponding to rotation about the milling tool head pivot axis 240), and the milling tool head 338 is configured to be selectively translated relative to the milling tool head base 340 (corresponding to motion along the X2-axis 244). In examples in which the carriage base 362 may be pivotally adjusted relative to the carriage mount 360, such as in the milling tool head assembly 210 of the second example portable machine tool 400, the milling tool head assembly 210 may be described as having up to eight degrees of freedom or as providing up to eight degrees of freedom for the associated cutting tool 352. More specifically, these eight degrees of freedom comprise the five degrees of freedom described above, in addition to the three rotational degrees of freedom through which the carriage base 362 may pivot relative to the carriage mount 360. While the present disclosure generally relates to examples in which the milling tool head assembly 210 is utilized in conjunction with the portable machining kit 100 and/or the portable machine tool 200, this is not required, and it additionally is within the scope of the present disclosure that the milling tool head assembly 210 may be utilized in conjunction with any suitable apparatus, milling tool, milling machine, etc.

Turning now to FIGS. 17-22, in some examples, the portable machining kit 100 and/or the portable machine tool 200 comprises, and/or is configured to be operatively utilized in conjunction with, a remote control system 500 for enabling and/or facilitating remote operation of the portable machine tool. In particular, while the remote control system 500 primarily is described herein with reference to operation in conjunction with the portable machine tool 200, it is to be understood that the remote control system 500 additionally or alternatively may be utilized with any of a variety of machine tools, such as with elements of the portable machining kit 100.

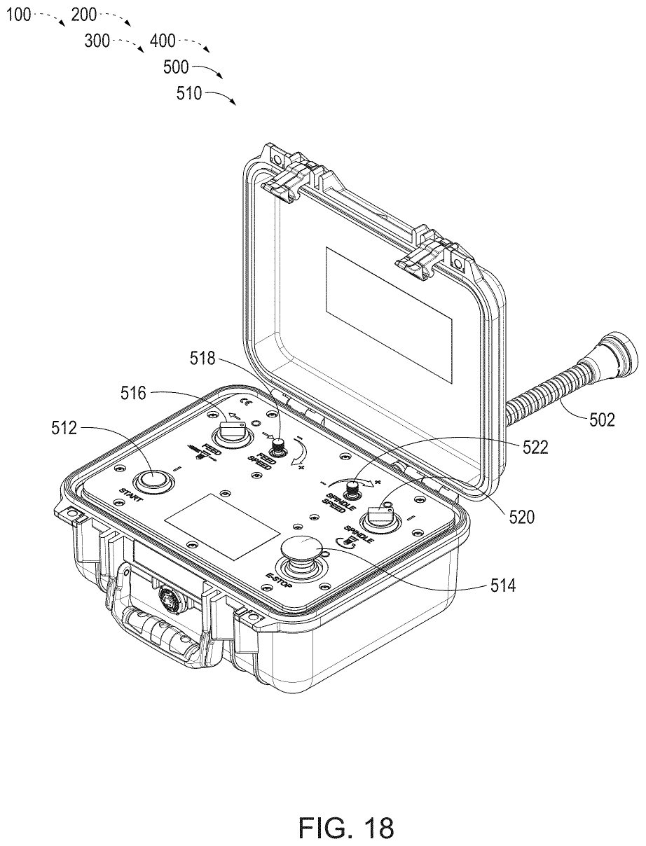

FIG. 17 is a schematic circuit diagram representing components and functionalities of an example of the remote control system 500, while FIGS. 18-22 illustrate aspects of a more specific example of the remote control system 500. As schematically illustrated in FIG. 17 and less schematically illustrated in FIG. 18, the remote control system 500 comprises an operator pendant 510 configured to receive a user input and to generate a control signal for remote operation of the portable machine tool 200. The remote control system 500 additionally comprises a control tether 502 extending from the operator pendant to convey the control signal to another component of the remote control system 500 and/or of the portable machine tool 200. In some examples, and as schematically illustrated in FIG. 17, the remote control system 500 additionally comprises one or more pneumatic conduits 504 configured to convey the pneumatic air flow from the pneumatic conditioning unit 530 to another component of the remote control system 500 and/or to the portable machine tool 200.

Remote control system 500 may be configured to enable and/or facilitate remote operation and/or control of any of a variety of components of the portable machine tool 200. Such configurations thus may enable the user to at least partially control operation of the milling tool head assembly 210 while the milling tool head 338 translates along the primary tool path and/or while the cutting tool 352 operates to machine the workpiece without physically approaching a moving component of the portable machine tool 200 that could pose a safety hazard. For example, the remote control system 500 may be configured to permit the user to selectively and remotely initiate and cease, via the control signal, translation of the milling tool head 338 along the primary tool path, and/or to select a speed and/or direction of translation of the milling tool head 338. In particular, the control signal may be configured to permit the user to selectively and remotely initiate and cease operation of the motor 216 to translate the milling tool head assembly 210 along the bridge 206. More specifically, in some examples, and as illustrated in FIGS. 17-18, the operator pendant 510 comprises a machine start control 512 that is configured to initiate translation of the milling tool head 338 along the primary tool path and a machine stop control 514 that is configured to cease translation of the milling tool head 338 along the primary tool path. In such examples, each of the machine start control 512 and the machine stop control 514 may comprise and/or be any suitable control input, such as a button.

In some examples, the remote control system 500 further is configured to permit the user to selectively and remotely command the milling tool head 338, via the control signal, to translate along the primary tool path along either of a first direction or a second direction that is opposite the first direction. Specifically, in such examples, the first direction may correspond to a positive direction along the X-axis 242, and the second direction may correspond to a negative direction along the X-axis 242. In such examples, and as illustrated in FIGS. 17-18, the operator pendant 510 may comprise a feed direction control 516 that is configured to selectively transition the milling tool head 338 between translating along the primary tool path in the first direction and in the second direction. As a more specific example, the feed direction control 516 may comprise and/or be a switch.

Additionally or alternatively, in some examples, the remote control system 500 further is configured to permit the user to selectively and remotely vary, via the control signal, a speed at which the milling tool head 338 travels along the primary tool path (e.g., in the first direction or in the second direction). In particular, and as illustrated in FIGS. 17-18, the operator pendant 510 may comprise a feed speed control 518 that is configured to regulate the speed at which the milling tool head 338 travels along the primary tool path. As a more specific example, the feed speed control 518 may comprise and/or be a rotary control and/or a gas regulator.

Additionally or alternatively, the remote control system 500 may be configured to permit the user to selectively and remotely initiate and cease, via the control signal, rotation of the cutting tool spindle 346, and/or to select a speed and/or direction of the rotational of the cutting tool spindle 346. In particular, the remote control system 500 may be configured to selectively and remotely vary, via the control signal, a rotational speed at which the cutting tool spindle 346 rotates the cutting tool 352. More specifically, in some examples, and as illustrated in FIGS. 17-18, the operator pendant 510 comprises a spindle start/stop control 520 that is configured to selectively initiate and cease rotation of the cutting tool spindle 346 and/or a spindle speed control 522 configured to regulate the rotational speed at which the cutting tool spindle 346 rotates the cutting tool 352.

As used herein, the term “control signal,” as used to describe a signal that is conveyed between components of remote control system 500 and/or of the portable machine tool 200, is intended to refer to any suitable material, property, phenomenon, and/or information for operatively controlling the portable machine tool 200 as described herein. For example, the control signal may comprise and/or be a flow, a flow rate, and/or a pressure of a fluid that (such as pneumatic air or a hydraulic fluid) is conveyed to the portable machine tool 200. In this manner, the control signal may comprise and/or be one or more flows of the pneumatic air flow in respective pneumatic conduits 504, such that the control tether 502 may comprise one or more such pneumatic conduits 504. While the present disclosure generally relates to examples in which the control signal is a pneumatic signal (i.e., a property of a pneumatic air flow), this is not required, and it additionally is within the scope of the present disclosure that the control signal may comprise and/or be any of a variety of signals and/or flows, examples of which comprise a hydraulic fluid flow and/or an electrical signal.

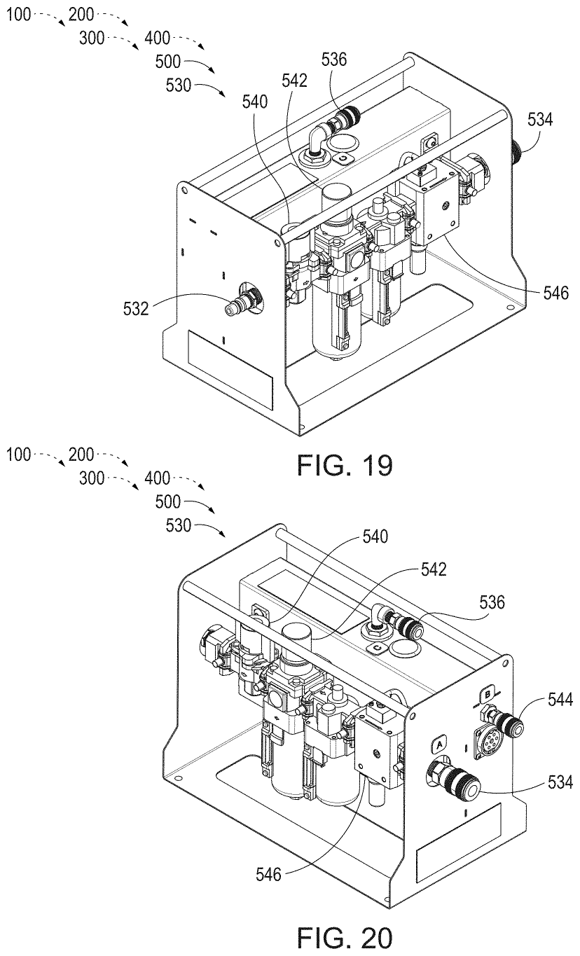

In some examples, and as discussed, one or more components of the portable machine tool 200 (such as the motor 216 and/or the second motor 336) may be pneumatically powered. In such examples, and as schematically illustrated in FIG. 17 and less schematically illustrated in FIGS. 19-20, the portable machine tool 200 and/or the remote control system 500 additionally may comprise a pneumatic conditioning unit 530 configured to receive and condition a pneumatic air source, such as via filtering and/or flow control. More specifically, in some examples, and as shown in FIGS. 17 and 19-20, the pneumatic conditioning unit 530 comprises a pneumatic air inlet 532 configured to receive a pneumatic air flow and a main air supply outlet 534 configured to supply at least a portion of the pneumatic air flow to another component of the remote control system 500 and/or to the portable machine tool 200.

As additionally illustrated in FIGS. 17-18, the pneumatic conditioning unit 530 also may comprise a lockout valve 540 configured to interrupt a flow of pneumatic air from the pneumatic air inlet 532 to the main air supply outlet 534, such as to selectively cease and/or prevent operation of the milling tool head assembly 210 to machine the workpiece. In such examples, the lockout valve 540 may be configured to be selectively transitioned between a flow state, in which the pneumatic air flow may flow from pneumatic air inlet 532 to the main air supply outlet 534, and a lockout state, in which the pneumatic air flow is restricted from reaching the main air supply outlet 534.

As additionally illustrated in FIGS. 17-18, the pneumatic conditioning unit 530 also may comprise a flow control valve 542 for selectively modulating a flow rate and/or a pressure of the pneumatic air supply, such as to selectively modulate a speed (e.g., a maximum speed) at which the motor 216 and/or the second motor 336 may operate. For example, it may be desirable to translate the milling tool head assembly 210 along the bridge 206 and/or to rotate the cutting tool 352 at a relatively slow rate when machining heavy materials, or for more precise cutting. Alternatively, it may be desirable to translate the milling tool head assembly 210 along the bridge 206 and/or to rotate the cutting tool 352 at a relatively fast rate for machining harder materials with carbide tooling. In some examples, and as discussed herein, the operator pendant 510 also may enable selective variation of the flow rate and/or pressure of the pneumatic air delivered to the portable machine tool 200. Thus, in such examples, the flow control valve 542 may be described as being operable to selectively establish a maximum flow rate and/or pressure of the pneumatic air flow to the portable machine tool 200. In particular, in some examples, the flow control valve 542 is configured to enable selective variation of a flow rate and/or a pressure of the pneumatic air that is supplied to the motor 216 and/or to the second motor 336. In this manner, the control signal generated by operator pendant 510 may be described as being configured to regulate the pneumatic air flow to the portable machine tool 200 to selectively translate the milling tool head assembly 210 and/or to rotate the cutting tool 352, such as at a desired rate.

In some examples, and as illustrated in FIGS. 17 and 21-22, the remote control system 500 additionally comprises an auxiliary conditioning unit 550. In such examples, the auxiliary conditioning unit 550 is configured to receive the pneumatic air flow from the pneumatic conditioning unit 530 and to supply the pneumatic air flow to the portable machine tool 200 at least partially based upon the user input received by the operator pendant 510. In particular, whereas the operator pendant 510 is configured to receive the user input corresponding to the desired operation of the portable machine tool 200, the pneumatic valves that are actuated to enable such operation may be too large and/or heavy to incorporate into the operator pendant 510 without compromising the portability of the operator pendant 510. Accordingly, in such examples, the operator pendant may be configured to transmit the control signal to the auxiliary conditioning unit 550, which in turn comprises valves (e.g., pilot-actuated valves) that are actuated at least partially based upon the control signal. In this manner, utilizing the auxiliary conditioning unit 550 in conjunction with the operator pendant 510 may enable the operator pendant 510 itself to be relatively small, lightweight, and/or portable while still enabling the remote control functionality offered by the valves contained within the auxiliary conditioning unit 550.

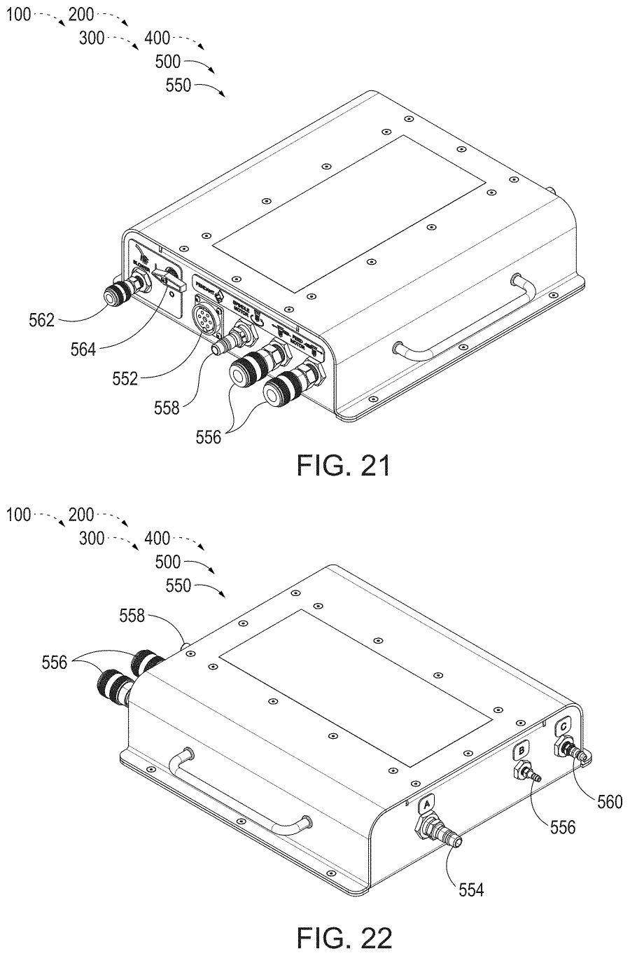

The auxiliary conditioning unit 550 may comprise any of a variety of inputs, outputs, and/or controls. For example, and as illustrated in FIGS. 17 and 22, the auxiliary conditioning unit 550 may comprise a main air supply inlet 554 that is configured to receive the pneumatic air flow from the main air supply outlet 534. Additionally or alternatively, and as illustrated in FIGS. 17 and 21-22, the auxiliary conditioning unit 550 may comprise a feed motor air outlet 556 that is configured to convey at least a portion of the pneumatic air flow to the portable machine tool 200, such as to the motor 216, to translate the milling tool head 338 along the primary tool path. In particular, FIGS. 17 and 21-22 illustrate an example in which the auxiliary conditioning unit comprises a pair of feed motor air outlets 556, respectively corresponding to operation to translate the milling tool head 338 along the first direction or the second direction of the primary tool path. Additionally or alternatively, and as illustrated in FIGS. 17 and 21-22, the auxiliary conditioning unit 550 may comprise a spindle motor air outlet 558 that is configured to convey at least a portion of the pneumatic air flow to the portable machine tool 200, such as to the motor 216, to rotate the cutting tool spindle 346. As additionally shown in FIGS. 17 and 21, the auxiliary conditioning unit 550 also may comprise an operator pendant interface 552 configured to receive the control signal from the operator pendant 510 (shown in FIGS. 17-18). For example, the control tether 502 may be configured to be operatively coupled to, and/or to interface with, the operator pendant interface 552 to convey the control signal between the operator pendant 510 and the auxiliary conditioning unit 550.

In some examples, the remote control system 500 additionally may comprise one or more features for utilizing the pneumatic air flow to blow away chips that are generated by milling the workpiece. In particular, in some examples, and as illustrated in FIGS. 17-18, the pneumatic conditioning unit 530 further comprises a chip blower air supply outlet 536 that is configured to convey a portion of the pneumatic air flow to another component of the remote control system 500 and/or to the portable machine tool 200. More specifically, and as illustrated in FIGS. 17 and 21-22, the auxiliary conditioning unit 550 may comprise a chip blower air supply inlet 560 (illustrated in FIGS. 17 and 22) configured to receive the portion of the pneumatic air flow from the chip blower air supply outlet 536 and/or a chip blower air outlet 562 (illustrated in FIGS. 17 and 21) configured to convey at least a portion of the pneumatic air flow to the portable machine tool 200 to facilitate removal of chips produced during operative use of the portable machine tool 200 to machine the workpiece. In such examples, and as illustrated in FIGS. 17 and 21, the auxiliary conditioning unit 550 additionally may comprise a chip blower valve 564 that is configured to selectively initiate and cease a flow of the pneumatic air flow from the chip blower air outlet 562.

As discussed, FIG. 17 is a schematic pneumatic circuit diagram illustrating an example of the operator pendant 510 that interfaces with the auxiliary conditioning unit 550 via the control tether 502. That is, in the example of FIG. 17, the control tether 502 is configured to convey the control signal in the form of pneumatic pressure and/or air flow between the operator pendant 510 and the auxiliary conditioning unit 550, such as via one or more pneumatic conduits 504. While the pneumatic circuit diagram of FIG. 17 pertains to an example in which the control signal takes the form of a pneumatic pressure signal, this is not required, and it additionally is within the scope of the present disclosure that the control signal may comprise and/or be any appropriate signal, such as an electrical control signal. In such examples, the electrical control signal may be conveyed from the operator pendant 510 to an electrical control module, such as may control the operation of the milling tool head assembly 210.

In some examples, the remote control system 500, the operator pendant 510, the pneumatic conditioning unit 530, and/or the auxiliary conditioning unit 550 may be configured to prevent an inadvertent and/or unexpected operation of the portable machine tool 200. For example, when the motor 216 is pneumatically powered, operation of the portable machine tool 200 may be inadvertently ceased by an interruption in the supply of pneumatic pressure from the auxiliary conditioning unit 550 to the motor 216, such as by pinching a pneumatic conduit 504 and/or the control tether 502. In some prior art examples, when the flow in the pneumatic conduit 504 is reestablished subsequent to such an inadvertent interruption, the motor 216 may unexpectedly resume operation (such as to translate the milling tool head assembly 210 and/or to rotate the cutting tool 352), introducing a risk of injury to a user positioned near the milling tool head assembly. Accordingly, the remote control system 500 may be configured such that, after an interruption of pneumatic pressure supplied to the portable machine tool 200, the supply of pneumatic pressure to the portable machine tool 200 may be reestablished only via selective and deliberate user input, such as via the machine start control 512 of the operator pendant 510.

More specifically, in some examples, the remote control system 500 is configured to be transitioned between a running configuration, in which the remote control system 500 operates to direct the pneumatic air flow from the pneumatic air inlet 532 to the portable machine tool 200, and a stopped configuration, in which the remote control system 500 operates to restrict the pneumatic air flow from flowing to the portable machine tool. In such examples, the machine start control 512 may be configured to receive a user input to selectively transition the remote control system 500 from the stopped configuration to the running configuration. Similarly, the machine stop control 514 may be configured to receive a user input to selectively transition the remote control system 500 from the running configuration to the stopped configuration. In such examples, the remote control system 500 also may be configured to automatically transition from the running configuration to the stopped configuration when the pneumatic airflow to the portable machine tool 200 is interrupted, and to remain in the stopped configuration until a user subsequently selectively operates the machine start control 512. Stated differently, in such examples, the remote control system 500 may be configured to transition from the stopped configuration to the running configuration only when the pneumatic air flow to the portable machine tool 200 is unblocked and when the machine start control 512 is operated to transition the remote control system 500 to the running configuration. In such examples, the remote control system 500 may be described as exhibiting a low-pressure safety dropout functionality.

As a more specific example, and as illustrated in FIGS. 17 and 22, the auxiliary conditioning unit 550 may comprise a low pressure dropout outlet 566 that is configured to convey a portion of the control signal to the pneumatic conditioning unit 530. Specifically, in such examples, and as illustrated in FIGS. 17 and 19-20, the pneumatic conditioning unit 530 may comprise a low pressure dropout inlet 544 that is configured to receive a portion of the pneumatic air flow, such as from the low pressure dropout outlet 566, and a low pressure dropout valve 546. The low pressure dropout valve 546 is configured to restrict the flow of the pneumatic air inlet 532 to the main air supply outlet 534 to transition the remote control system 500 to the stopped configuration when a pressure of the pneumatic air flow received at the low pressure dropout inlet 544 falls below a predetermined threshold pressure.

Further aspects, features, and/or components of remote control systems that may be utilized in conjunction with remote control systems 500 according to the present disclosure are disclosed in U.S. Patent Application Publication No. 2021/0213578, the complete disclosure of which is incorporated by reference.

FIG. 23 is a flowchart depicting examples of methods 30, according to the present disclosure, of operating a portable machining kit and/or a portable machine tool, such as the portable machining kit 100 and/or the portable machine tool 200 disclosed herein. As shown in FIG. 23, methods 30 comprise at least fixedly coupling (at 32) a machine frame of a portable machine tool to a workpiece; while the machine frame is fixedly coupled to the workpiece, facing (at 34) an annular planar surface on the workpiece using a facing tool head assembly by rotating a rotating ring of the portable machine tool relative to the machine frame; and, while the machine frame is fixedly coupled to the workpiece, milling (at 38) the linear planar surface using a milling tool head assembly. In some examples, the portable machine tool that is fixedly coupled to the workpiece is a flange facer 102 of a portable machining kit 100, discussed in greater detail herein in connection with FIG. 4. In such examples, the machine frame and the rotating ring are the machine frame 104 and the rotating ring 106 of the flange facer 102, and the facing tool head assembly is a component of the flange facer tool assembly 108 of the flange facer 102. In other examples, the portable machine tool that is fixedly coupled to the workpiece is a portable machine tool 200, discussed in greater detail herein in connection with FIGS. 5-16.

By “fixedly coupling,” it is meant that, while the machine frame may be subsequently decoupled from the workpiece, as a whole, it does not move relative to the workpiece when it is fixedly coupled thereto. That said, component parts of the machine frame, such as a drive train operable to rotate the rotating ring, may in fact move. By “locking the rotating ring relative to the machine frame,” it is meant that the rotating ring is selectively (e.g., by a user) and temporarily restricted from rotating relative to the machine frame. This operation may be accomplished in any suitable manner, including, for example, with an integral clamping mechanism of the portable machine tool, with a locking rod or other structure that is selectively extended through aligned holes in the machine frame and rotating ring, etc. When the rotating ring is operably locked to the machine frame, the milling step may be performed without the rotating ring inadvertently rotating and detrimentally affecting a desired (linear) cutting path of the milling tool head assembly.

A “tool head assembly” is an assembly (such as the milling tool head assembly 210 disclosed herein) that comprises a corresponding cutting tool (such as the cutting tool 352 disclosed herein) or that is configured to operatively receive a corresponding cutting tool for performing the corresponding machining. Accordingly, a “facing tool head assembly” when including a facing cutting tool is configured to perform a facing operation (i.e., machine an annular planar surface), and a “milling tool head assembly” when including a milling cutting tool is configured to perform a milling operation (i.e., machine a linear planar surface).

In some examples, the portable machine tool may be described as an outer-diameter (OD) mounted portable machine tool, such as a portable machine tool that is configured to clamp against the outer surface of a cylindrical workpiece. In some examples, the workpiece is a tube sheet of a shell-and-tube heat exchanger, the annular planar surface is an annular circular gasket surface of the tube sheet, and the linear planar surface is a linear groove of the tube sheet; however, methods 30 may be used to machine annular and linear planar surfaces of any suitable workpiece and not exclusively tube sheets of shell-and-tube heat exchangers.

In some examples, methods 30 further comprise restricting (at 35) rotation of the rotating ring relative to the machine frame, such that the milling (at 38) is performed while the rotating ring is restricted from being rotated. Accordingly, when the milling operation is performed, the rotating ring will not rotate as a result of torques applied to the rotating ring as a result of the milling operation. In such methods, the restricting (at 35) may be accomplished in any suitable manner. For example, the static torque, or resistance, of a motor and/or associated gear box or gearing may be sufficient to restrict rotation of the rotating ring relative to the machine frame. In some examples, the restricting (at 35) comprises locking (at 36) the rotating ring relative to the machine frame. For example, a locking structure (such as the locking structure 114 and/or the locking structure 222 disclosed herein) may be provided that is configured to selectively and operatively restrict the rotating ring from rotating relative to the machine frame. With continued reference to FIG. 23, some methods 30 further comprise, while the machine frame is fixedly coupled to the workpiece and prior to the (optional) restricting (at 35), rotating (at 40) the rotating ring relative to the machine frame to align the milling tool head assembly relative to the workpiece for milling the linear planar surface using the milling tool head assembly. When the optional restricting (at 35) is performed, it is performed following the rotating (at 40). In other words, the rotating ring is rotated to a desired position relative to the machine frame and thus relative to a workpiece to be milled, and then the rotating ring is restricted, or locked, in place while the milling (at 38) is performed.

In yet further examples, when the workpiece comprises more than one linear planar surface to be machined, and when at least two linear planar surfaces are non-parallel to each other, some methods 30 further comprise rotating (at 42) the rotating ring relative to the machine frame to align the milling tool head assembly relative to the workpiece for milling a second linear planar surface on the workpiece. In some such examples, the methods 30 comprise again restricting (at 44) the rotating ring from rotation relative to the machine frame and, subsequent to the again restricting (at 44) the rotating ring, milling (at 46) the second linear planar surface using the milling tool head assembly.

When the workpiece comprises more than one linear planar surface to be machined, and when at least two linear planar surfaces are parallel to each other, some methods 30 further comprise translating (at 41) the milling tool head assembly relative to the rotating ring to align the milling tool head assembly relative to the workpiece for milling a second linear planar surface on the workpiece using the milling tool head assembly. In more specific examples, when the milling tool head assembly is operatively coupled to a bridge, the bridge is translated relative to the rotating ring to align the milling tool head assembly with the second linear planar surface.

Some examples of methods 30 further comprise, while the machine frame is fixedly coupled to the workpiece, milling (at 48) a chamfer on a portion of the workpiece extending away from where the annular planar surface and the linear planar surface intersect or otherwise meet or terminate, or on a portion of the workpiece extending away from where two linear planar surfaces intersect or otherwise meet or terminate. Herein, these portions of a workpiece may be described as being between the annular planar surface and the linear planar surface or between a first linear planar surface and a second linear planar surface. Examples of these portions of workpieces in the form of tube sheets of shell-and-tube heat exchangers are illustrated in FIGS. 1-3, with the corresponding chamfers indicated at 20. In some examples, the annular planar surface is coplanar with one or more linear planar surfaces, such as in the example tube sheets of FIGS. 1 and 2, while in other examples, the annular planar surface is not coplanar with one or more linear planar surfaces, such as in the example tube sheet of FIG. 3.

Some such methods 30 that comprise milling (at 48) a chamfer, further comprise, prior to the milling (at 48) the chamfer, adjusting (at 50) the milling tool head assembly to adjust an angle of a secondary tool path of the milling tool head assembly relative to the workpiece, as disclosed herein with reference to the milling tool head assembly 210. Typically, and as discussed herein, a milling tool head assembly has a cutting path (e.g., a primary tool path) along (i.e., parallel to) a bridge of a milling machine, along which the milling tool head assembly is translated to mill a linear planar surface. However, in some methods 30, the milling tool head assembly is configured to provide a secondary tool path that is non-parallel to a corresponding bridge of the portable machine tool. Accordingly, this secondary tool path may be used to machine chamfers between the annular planar surface and the linear planar surface and/or between two linear planar surfaces. The example milling tool head assembly 210 of the first example portable machine tool 300 of FIGS. 6-10 and shown in detail in FIG. 10 and the example milling tool head assembly 210 of the second example portable machine tool 400 of FIGS. 11-16 provide such functionality and may be used to implement such methods 30.

In some methods 30, the facing (at 34) the annular planar surface is performed prior to the milling (at 38) the linear planar surface. Accordingly, some such examples further comprise, while the machine frame is fixedly coupled to the workpiece and after the facing (at 34), removing (at 52) the facing tool head assembly from the rotating ring; and while the machine frame is fixedly coupled to the workpiece, after the removing (at 52), and prior to the milling (38), mounting (54) the milling tool head assembly to the rotating ring.

In other examples of methods 30, the milling (at 38) the linear planar surface is performed prior to the facing (at 34) the annular planar surface. Accordingly, some such examples further comprise, while the machine frame is fixedly coupled to the workpiece and after the milling (at 38), removing (at 56) the milling tool head assembly from the rotating ring; and while the machine frame is fixedly coupled to the workpiece, after the removing (at 56), and prior to the facing (at 34), mounting (at 58) the facing tool head assembly to the rotating ring.

In some examples of methods 30, the portable machine tool is a flange facer, and with continued reference to FIG. 23, such methods may further comprise mounting (at 60) a milling machine to the rotating ring of the flange facer. Such example methods 30 may be performed utilizing a portable machining kit 100, discussed in greater detail below with respect to FIG. 4. In some examples in which the portable machine tool is a flange facer, the milling machine comprises the milling tool head assembly used to perform the milling (at 38) of the linear planar surface and optionally the milling (at 48) of a chamfer. In some such methods, the removing (at 52) the facing tool head assembly from the rotating ring comprises removing (at 62) the facing tool head assembly and a bridge of the flange facer from the rotating ring. In yet further examples that comprise mounting (at 60) a milling machine to the rotating ring of the flange facer, the flange facer is an outer-diameter (OD) mount flange facer and/or the milling machine is a gantry milling machine. In view of the above, some methods according to the present disclosure may be broadly described as using a machine frame of a flange facer and a rotating ring of the flange facer to mount a milling machine to a workpiece; and machining the workpiece using the milling machine when it is coupled to the rotating ring of the flange facer.

Also within the scope of the present disclosure are methods of retrofitting a flange facer to perform methods 30 in which the portable machine tool is a flange facer. For example, such methods of retrofitting may comprise creating a mounting structure on the rotating ring of the flange facer, with the mounting structure being configured to provide for operative mounting of a milling machine to the rotating ring of the flange facer. For example, the mounting structure may comprise holes in the rotating ring, with the holes in the rotating ring being configured to align with holes in the milling machine for receipt of fasteners to operatively mount the milling machine to the rotating ring. Additionally or alternatively, adapter brackets may be created and/or used to operatively mount the milling machine to a retrofitted flange facer.

In other examples, and with continued reference to FIG. 23, rather than mounting a milling machine to the rotating ring of a flange facer, some methods 30 further comprise, prior to the facing (at 34), mounting (at 58) the facing tool head assembly to a bridge of the portable machine tool; and prior to the milling (at 38), mounting (at 54) the milling tool head assembly to the bridge. That is, in such examples, the mounting (at 58) the facing tool head assembly and the mounting (at 54) the milling tool head assembly are similar to the previously disclosed mounting (at 58) and mounting (at 54), with the exception that these steps now describe mounting the corresponding components to the bridge of the portable machine tool rather than to the rotating ring of the flange facer. Such example methods 30 may be performed utilizing a portable machine tool 200, discussed in greater detail herein with respect to FIG. 5. In other words, rather than relying upon providing a kit that comprises both a flange facer and a milling machine, a single portable machine tool may be used both with a facing tool head assembly and with a milling tool head assembly to perform such methods 30. Such portable machine tools additionally or alternatively may be described as combination flange facer and milling machines. In some such examples in which the facing tool head assembly and the milling tool head assembly each are mounted to the bridge at respective times, methods 30 further comprise, prior to the mounting (at 54), removing (at 52) the facing tool head assembly from the bridge, and/or prior to the mounting (at 58), removing (at 56) the milling tool head assembly from the bridge. That is, in such examples, the removing (at 52) the facing tool head assembly and the removing (at 56) the milling tool head assembly are similar to the previously disclosed removing (at 52) and removing (at 56), with the exception that these steps now describe removing the corresponding components from the bridge of the portable machine tool rather than from the rotating ring of the flange facer. In view of the above, some methods according to the present disclosure may be broadly described as machining each of an annular planar surface and a linear planar surface of a workpiece using a combination flange facer and milling machine. Moreover, in such examples, the mounting and removing of the facing tool head assembly and the milling tool head assembly may be performed manually by an operator without the need for any hoisting equipment. That is, the facing tool head assembly and the milling tool head assembly may be constructed so as to weigh less than a threshold weight, such as less than 50 pounds, less 40 pounds, or less than 30 pounds, with these examples being illustrative and non-exclusive.

Illustrative, non-exclusive examples of inventive subject matter according to the present disclosure are described in the following enumerated paragraphs:

A. A milling tool head assembly (210), comprising:

a milling tool head carriage (316), and

a milling tool head (338),

wherein the milling tool head (338) comprises:

a milling tool head base (340) that is coupled to the milling tool head carriage (316), and a milling tool carrier (342) that is configured to be operatively coupled to a cutting tool (352) that is configured to machine a workpiece wherein the milling tool carrier (342) is configured to travel along a primary tool path relative to the workpiece, and wherein the milling tool carrier (342) is slidingly coupled to the milling tool head base (340) to define a secondary tool path of the milling tool carrier (342) relative to the workpiece.

A1. The milling tool head assembly (210) of paragraph A, wherein the milling tool head carriage (316) is configured to be operatively coupled to a track (314) of a machine tool and to translate along the track (314) to translate the milling tool head (338) along the track (314), and wherein the track (314) defines the primary tool path.

A1.1. The milling tool head assembly (210) of paragraph A1.1, wherein the track (314) is comprised in a bridge (206) of the machine tool, and wherein the bridge (206) is configured to be operatively coupled to the workpiece.

A2. The milling tool head assembly (210) of any of paragraphs A-A1.1, wherein the primary tool path extends along a direction parallel to an X-axis (242), optionally wherein a/the track (314) defines the X-axis (242), wherein the secondary tool path extends along an X2-axis (244), and wherein the milling tool head base (340) is configured to pivot relative to the milling tool head carriage (316) about a milling tool head pivot axis (240) to selectively adjust an angle between the X2-axis (244) and the X-axis (242).

A2.1. The milling tool head assembly (210) of paragraph A2, wherein the milling tool head pivot axis (240) is at least substantially perpendicular to one or both of the X-axis (242) and the X2-axis (244).

A3. The milling tool head assembly (210) of any of paragraphs A-A2.1, wherein the milling tool carrier (342) is slidingly coupled to the milling tool head base (340) via a sliding joint (344), and optionally wherein the sliding joint (344) comprises, and optionally is, a dovetail joint.

A3.1. The milling tool head assembly (210) of paragraph A3, wherein the sliding joint (344) is configured to selectively permit the milling tool carrier (342) to translate relative to the milling tool head base (340) along the secondary tool path.

A3.2. The milling tool head assembly (210) of any of paragraphs A3-A3.1, wherein the sliding joint (344) is configured to restrict the milling tool carrier (342) from translating relative to the milling tool head base (340) along a direction at least substantially perpendicular to the secondary tool path.

A3.3. The milling tool head assembly (210) of any of paragraphs A3-A3.2, wherein the sliding joint (344) is configured to restrict the milling tool carrier (342) from rotating relative to the milling tool head base (340).

A3.4. The milling tool head assembly (210) of any of paragraphs A3-A3.3, wherein the sliding joint (344) is configured to selectively restrict the milling tool carrier (342) from translating relative to the milling tool head base (340).

A3.4.1. The milling tool head assembly (210) of any of paragraphs A-A3.4, further comprising a milling tool carrier lock mechanism (372) that is configured to selectively engage each of the milling tool carrier (342) and the milling tool head base (340) to selectively restrict the milling tool carrier (342) from translating relative to the milling tool head base (340).

A4. The milling tool head assembly (210) of any of paragraphs A-A3.4.1, further comprising a tool head drive input shaft (350) that is configured to receive a rotary input to selectively translate the milling tool carrier (342) relative to the milling tool head base (340) along the secondary tool path.

A5. The milling tool head assembly (210) of any of paragraphs A-A4, further comprising a cutting tool spindle (346) that extends through the milling tool carrier (342) along a Z-axis (248), wherein the cutting tool spindle (346) is configured to one or both of support the cutting tool (352) relative to the workpiece and rotate the cutting tool (352) relative to the workpiece, and optionally wherein the cutting tool spindle (346) is configured to be selectively adjusted relative to the milling tool carrier (342) along the Z-axis (248).

A5.1. The milling tool head assembly (210) of paragraph A5, wherein the Z-axis is at least substantially parallel to a/the milling tool head pivot axis (240).

A5.2. The milling tool head assembly (210) of any of paragraphs A5-A5.1, further comprising a spindle adjustment input shaft (348) that is configured to receive a rotary input to selectively translate the cutting tool spindle (346) relative to the milling tool carrier (342) along the Z-axis (248).

A6. The milling tool head assembly (210) of any of paragraphs A-A5.2, wherein the milling tool head carriage (316) is configured to selectively adjust an orientation of the milling tool carrier (342) relative to one or more of at least a portion of the milling tool head carriage (316), a/the X-axis (242), a/the track (314), a/the bridge (206), and the workpiece, optionally wherein the milling tool head carriage (316) is configured to selectively pivot the milling tool head (338) relative to one or more of at least a portion of the milling tool head carriage (316), a/the X-axis (242), a/the track (314), a/the bridge (206), and the workpiece about one or more of:

(i) an axis that is at least substantially parallel to a/the X-axis (242),

(ii) an axis that is at least substantially parallel to a/the Z-axis (248),

(iii) an axis that is at least substantially parallel to a Y-axis (246) that is perpendicular to each of the X-axis (242) and the Z-axis (248), and

(iv) an axis that is at least substantially parallel to a/the milling tool head pivot axis (240).

A6.1. The milling tool head assembly (210) of paragraph A6, wherein one or both of the machine tool and the bridge (206) comprises a carriage mount (360) that is operatively coupled to the track (314), and wherein the milling tool head carriage (316) comprises a carriage base (362) that is configured to be adjustably and operatively coupled to the carriage mount (360).

A6.1.1. The milling tool head assembly (210) of paragraph A6.1, wherein the milling tool head carriage (316) comprises one or more carriage fasteners (364) and one or more carriage adjustment mechanisms (366), wherein the carriage base (362) is configured to be operatively coupled to the carriage mount (360) at least partially via the one or more carriage fasteners (364), wherein the one or more carriage fasteners (364) are configured to selectively and operatively retain the carriage base (362) in an at least substantially fixed orientation relative to the carriage mount (360) during operative use of the milling tool head assembly (210), and wherein the one or more carriage adjustment mechanisms (366) are configured to engage each of the carriage mount (360) and the carriage base (362) to at least partially define an orientation of the carriage base (362) relative to the carriage mount (360).

A6.1.1.1. The milling tool head assembly (210) of paragraph A6.1.1, wherein the one or more carriage adjustment mechanisms (366) are configured to adjust the orientation of the carriage base (362) relative to the carriage mount (360) while the one or more carriage fasteners (364) do not operatively retain the carriage base (362) in the at least substantially fixed orientation relative to the carriage mount (360).

A6.1.1.2. The milling tool head assembly (210) of any of paragraphs A6.1.1-A6.1.1.1, wherein the one or more carriage fasteners (364) comprise one or more mechanical fasteners, optionally one or more bolts.

A6.1.1.3. The milling tool head assembly (210) of any of paragraphs A6.1.1-A6.1.1.2, wherein the one or more carriage adjustment mechanisms (366) comprise one or more mechanical adjustment mechanisms, optionally, one or more set screws.

A6.1.2. The milling tool head assembly (210) of any of paragraphs A6.1-A6.1.1.3, wherein the milling tool head base (340) is pivotally coupled to the carriage base (362).

A7. The milling tool head assembly (210) of any of paragraphs A-A6.1.2, further comprising a secondary tool path angle adjustment mechanism (368) that is configured to selectively pivot the milling tool head base (340) relative to the milling tool head carriage (316) to at least partially define an orientation of the secondary tool path, optionally the orientation of the secondary tool path relative to one or more of a/the X-axis (242), a/the track (314), a/the bridge (206), and the workpiece.

A7.1. The milling tool head assembly (210) of any of paragraphs A-A7, further comprising a secondary tool path angle lock pin (370) that is configured to selectively restrict the milling tool head base (340) from pivoting relative to the milling tool head carriage (316).

A7.1.1. The milling tool head assembly (210) of paragraph A7.1, wherein the secondary tool path angle lock pin (370) is configured to selectively engage each of the milling tool head base (340) and the milling tool head carriage (316), optionally a/the carriage base (362), to selectively restrict the milling tool head base (340) from pivoting relative to the milling tool head carriage (316), optionally wherein the secondary tool path angle lock pin (370) is configured to be selectively inserted into any of a plurality of pin receivers defined in one or both of the milling tool head base (340) and the milling tool head carriage (316), optionally the carriage base (362).

A8. The milling tool head assembly (210) of any of paragraphs A-A7.1.1, further comprising the cutting tool (352), and optionally wherein the cutting tool (352) is operatively coupled to a/the cutting tool spindle (346).

B. A portable machining kit (100) for machining an annular planar surface and a linear planar surface on a workpiece, the portable machining kit (100) comprising:

a flange facer (102), comprising a machine frame (104), a rotating ring (106) that is rotatingly coupled to the machine frame (104), and a flange facer tool assembly (108) that is removably coupled to the rotating ring (106); and

a milling machine (110) configured to be operatively mounted to the rotating ring (106) of the flange facer (102).

B1. The portable machining kit (100) of paragraph B, further comprising:

one or more adapter brackets (112) configured to operatively mount the milling machine (110) to the rotating ring (106) of the flange facer (102).

B2. The portable machining kit (100) of any of paragraphs B-B1, further comprising:

at least one locking structure (114) configured to selectively lock the rotating ring (106) to the machine frame (104) to restrict rotation of the rotating ring (106) relative to the machine frame (104).

B3. The portable machining kit (100) of any of paragraphs B-B2, wherein the milling machine (110) is a gantry milling machine.

B4. The portable machining kit (100) of any of paragraphs B-B3, wherein the flange facer (102) is an outer-diameter (OD) mount flange facer.

B5. The portable machining kit (100) of any of paragraphs B-B4, wherein the milling machine (110) comprises a milling machine bridge (116) and a milling tool head assembly (118) coupled to the milling machine bridge (116).

wherein the milling machine bridge (116) is the bridge (206) of any of paragraphs A1.1-A8, and wherein the milling tool head assembly (118) is the milling tool head assembly (210) of any of paragraphs A-A8.

B5.1. The portable machining kit (100) of paragraph B5, wherein the milling machine bridge (116) is configured to be selectively translated relative to the rotating ring (106) of the flange facer (102) when the milling machine (110) is operatively coupled to the rotating ring (106).

B5.1.1. The portable machining kit (100) of any of paragraphs B5-B5.1, wherein the milling machine (110) further comprises a linear bed (130), and wherein the milling machine bridge (116) is configured to be selectively positioned along the linear bed (130).

B5.2. The portable machining kit (100) of any of paragraphs B5-B5.1.1, wherein the milling tool head assembly (118) is configured to be selectively adjusted to adjust an angle of a/the secondary tool path of the milling tool head assembly (118) relative to the milling machine bridge (116).

B5.3. The portable machining kit (100) of any of paragraphs B5-B5.2, wherein the milling tool head assembly (118) comprises a/the milling tool head (338) and a/the milling tool head carriage (316), wherein the milling machine bridge (116) comprises a/the track (314), wherein the milling tool head carriage (316) is configured to be operatively coupled to the track (314) and to translate along the track (314), and wherein the milling tool head (338) comprises:

a/the milling tool head base (340) that is pivotally coupled to the milling tool head carriage (316); and

a/the milling tool carrier (342) that is slidingly coupled to the milling tool head base (340) to define a/the secondary tool path of the milling tool head assembly (118).

B5.3.1. The portable machining kit (100) of paragraph B5.3, wherein the milling tool head assembly (118) further comprises a/the cutting tool spindle (346) that extends through the milling tool carrier (342) along a/the Z-axis (248), and wherein the cutting tool spindle (346) is configured to be selectively adjusted relative to the milling tool carrier (342) along the Z-axis (248).

B6. The portable machining kit (100) of any of paragraphs B-B5.3.1, further comprising a motor (120) configured to be selectively coupled to the flange facer (102) for operation thereof and to be selectively coupled to the milling machine (110) for operation thereof.

B7. The portable machining kit (100) of any of paragraphs B-B6, further comprising a manual adjuster (122) configured to selectively adjust an angular orientation of the rotating ring (106) relative to the machine frame (104).

B7.1. The portable machining kit (100) of paragraph B7, wherein the machine frame (104) comprises a drive input (124) configured to be selectively coupled to and decoupled from a/the motor (120) for operation of the flange facer (102), and wherein the manual adjuster (122) is configured to be selectively coupled to and decoupled from the drive input (124) for manual adjustment of the angular orientation of the rotating ring (106) relative to the machine frame (104).

C. A portable machine tool (200), comprising:

a machine frame (202) configured to be fixedly coupled to a workpiece to operatively support the portable machine tool (200) on the workpiece;

a rotating ring (204) that is rotatingly coupled to the machine frame (202);

a bridge (206) coupled to the rotating ring (204);

a facing tool head assembly (208) configured to be selectively coupled to and decoupled from the bridge (206), wherein the rotating ring (204) is configured to be selectively rotated relative to the machine frame (202) to rotate the facing tool head assembly (208) to operatively machine an annular planar surface on the workpiece when the facing tool head assembly (208) is coupled to the bridge (206); and

a milling tool head assembly (210) configured to be selectively coupled to and decoupled from the bridge (206), wherein the bridge (206) is configured to selectively translate the milling tool head assembly (210) along the bridge (206) to operatively machine a linear planar surface on the workpiece when the milling tool head assembly (210) is coupled to the bridge (206).

C1. The portable machine tool (200) of paragraph C, wherein the bridge (206) is the bridge of any of paragraphs B5-B7.1, and wherein the milling tool head assembly (210) is the milling tool head assembly (210) of any of paragraphs B-B7.1.

C2. The portable machine tool (200) of any of paragraphs C-C1, wherein the rotating ring (204) comprises a linear bed (212), and wherein the bridge (206) is configured to be selectively translated along a length of the linear bed (212), optionally along a direction parallel to a/the Y-axis (246).

C2.1. The portable machine tool (200) of paragraph C2, wherein the linear bed (212) comprises two spaced-apart bed portions (214), and wherein the bridge (206) extends between the two spaced-apart bed portions (214) in a gantry configuration.

C3. The portable machine tool (200) of any of paragraphs C-C2.1, wherein the rotating ring (204) is configured to be selectively restricted from rotating relative to the machine frame (202) for operation of the milling tool head assembly (210) when the milling tool head assembly (210) is coupled to the bridge (206).

C3.1. The portable machine tool (200) of paragraph C3, further comprising:

at least one locking structure (222) configured to selectively lock the rotating ring (204) to the machine frame (202) to restrict rotation of the rotating ring (204) relative to the machine frame (202).

C4. The portable machine tool (200) of any of paragraphs C-C3.1, wherein the milling tool head assembly (210) is configured to be selectively adjusted to adjust an angle of a/the secondary tool path of the milling tool head assembly (210) relative to the bridge (206) when the milling tool head assembly (210) is coupled to the bridge (206).

C4.1. The portable machine tool (200) of paragraph C4, wherein the bridge (206) comprises a/the track (314), wherein the milling tool head assembly (210) comprises a/the milling tool head carriage (316) that is configured to be operatively coupled to the track (314) and to translate along the track (314), wherein the milling tool head assembly (210) comprises a/the milling tool head (338), wherein the milling tool head (338) comprises:

a/the milling tool head base (340) that is pivotally coupled to the milling tool head carriage (316); and

a/the milling tool carrier (342) that is slidingly coupled to the milling tool head base (340) to define the secondary tool path of the milling tool head assembly (210).

C4.1.1. The portable machine tool (200) of paragraph C4.1, wherein the milling tool head assembly (210) further comprises a/the cutting tool spindle (346) that extends through the milling tool carrier (342) along a/the Z-axis (248), and wherein the cutting tool spindle (346) is configured to be selectively adjusted relative to the milling tool carrier (342) along the Z-axis (248).

C5. The portable machine tool of any of paragraphs C-C4.1.1, further comprising a motor (216);

wherein the motor (216) is configured to be selectively coupled to and decoupled from the machine frame (202), wherein the motor (216) is configured to selectively rotate the rotating ring (204) relative to the machine frame (202) when the motor (216) is coupled to the machine frame (202); and wherein the motor (216) is configured to be selectively coupled to and decoupled from the bridge (206), wherein the motor (216) is configured to selectively translate the milling tool head assembly (210) along the bridge (206) when the motor (216) is operatively coupled to the bridge (206).

C6. The portable machine tool (200) of any of paragraphs C-C5, further comprising a manual adjuster (218) configured to selectively adjust an angular orientation of the rotating ring (204) relative to the machine frame (202).

C6.1. The portable machine tool (200) of paragraph C6, wherein the machine frame (202) comprises a drive input (220) configured to be operatively and selectively coupled to a/the motor (216) for selective rotation of the rotating ring (204) relative to the machine frame (202), and wherein the manual adjuster (218) is configured to be operatively and selectively coupled to and decoupled from the drive input (220) for manual adjustment of the angular orientation of the rotating ring (204) relative to the machine frame (202).

C6.2. The portable machine tool (200) of any of paragraphs C6-C6.1, wherein the manual adjuster (218) comprises one or both of a gear box and a hand crank (334).

D. A remote control system (500) for a portable machine tool (200) that comprises a machine frame (202), a rotating ring (204) that is rotatingly coupled to the machine frame (202), and a milling tool head assembly (210) with a milling tool head (338) configured to convey a cutting tool (352) along a primary tool path to machine a linear planar surface on a workpiece, the remote control system (500) comprising:

an operator pendant (510) configured to receive a user input from a human user and to generate a control signal for remote operation of the portable machine tool (200); and

a control tether (502) extending from the operator pendant (510) to convey the control signal to another component of the remote control system.

D1. The remote control system (500) of paragraph D, wherein the milling tool head assembly (210) is the milling tool head assembly (210) of any of paragraphs A-A8.

D2. The remote control system (500) of any of paragraphs D-D1, wherein the portable machine tool (200) is the portable machine tool (200) of any of paragraphs C-C6.2.

D3. The remote control system (500) of any of paragraphs D-D2, wherein the remote control system (500) is configured to permit the user to selectively and remotely initiate and cease, via the control signal, translation of the milling tool head (338) along the primary tool path.

D3.1. The remote control system (500) of paragraph D3, wherein the operator pendant (510) comprises:

a machine start control (512) configured to initiate translation of the milling tool head (338) along the primary tool path, and

a machine stop control (514) configured to cease translation of the milling tool head (338) along the primary tool path.

D3.2. The remote control system (500) of any of paragraphs D3-D3.1, wherein the portable machine tool (200) further comprises a/the motor (216) configured to selectively translate the milling tool head assembly (210) along the bridge (206), and wherein the control signal is configured to permit the user to selectively and remotely initiate and cease operation of the motor (216) to translate the milling tool head assembly (210) along the bridge (206).

D4. The remote control system (500) of any of paragraphs D-D3.2, wherein the remote control system (500) is configured to permit the user to selectively and remotely command the milling tool head (338), via the control signal, to translate along the primary tool path along either of a first direction or a second direction that is opposite the first direction.

D4.1. The remote control system (500) of paragraph D4, wherein the operator pendant (510) comprises a feed direction control (516) configured to selectively transition the milling tool head (338) between translating along the primary tool path in the first direction and in the second direction.

D5. The remote control system (500) of any of paragraphs D-D4.1, wherein the remote control system (500) is configured to permit the user to selectively and remotely vary, via the control signal, a speed at which the milling tool head (338) travels along the primary tool path.

D5.1. The remote control system (500) of paragraph D5, wherein the operator pendant (510) comprises a feed speed control (518) configured to regulate the speed at which the milling tool head (338) travels along the primary tool path.

D6. The remote control system (500) of any of paragraphs D-D5, wherein the milling tool head assembly (210) comprises a/the cutting tool spindle (346) configured to support the cutting tool (352) relative to the workpiece and to rotate the cutting tool (352) relative to the workpiece, and wherein the remote control system (500) is configured to permit the user to one or both of:

(i) selectively and remotely initiate and cease, via the control signal, rotation of the cutting tool spindle (346), and

(ii) selectively and remotely vary, via the control signal, a rotational speed at which the cutting tool spindle (346) rotates the cutting tool (352).

D6.1. The remote control system (500) of paragraph D6, wherein the operator pendant (510) comprises one or both of:

a spindle start/stop control (520) configured to selectively initiate and cease rotation of the cutting tool spindle (346), and

a spindle speed control (522) configured to regulate the rotational speed at which the cutting tool spindle (346) rotates the cutting tool (352).

D7. The remote control system (500) of any of paragraphs D-D6.1, wherein the control signal comprises one or more of a pneumatic air flow, a hydraulic fluid flow, and an electrical signal.

D8. The remote control system (500) of any of paragraphs D-D7, wherein the control signal is configured to regulate a/the pneumatic air flow to a/the motor (216).

D9. The remote control system (500) of any of paragraphs D-D8, further comprising a pneumatic conditioning unit (530) configured to receive and condition a pneumatic air source.

D9.1. The remote control system (500) of paragraph D9, wherein the pneumatic conditioning unit (530) comprises:

a pneumatic air inlet (532) configured to receive a pneumatic air flow, and

a main air supply outlet (534) configured to supply at least a portion of the pneumatic air flow to another component of the remote control system (500) and/or to the portable machine tool (200).

D9.1.1. The remote control system of paragraph D9.1, wherein the control signal comprises, and optionally is, at least a portion of the pneumatic air flow.

D9.2. The remote control system (500) of any of paragraphs D9-D9.1.1, wherein the pneumatic conditioning unit (530) further comprises a chip blower air supply outlet (536) configured to convey a portion of the pneumatic air flow to another component of the remote control system (500) and/or to the portable machine tool (200).

D9.3. The remote control system (500) of any of paragraphs D9-D9.2, wherein the pneumatic conditioning unit (530) comprises a lockout valve (540) configured to selectively interrupt a flow of pneumatic air from a/the pneumatic air inlet (532) to a/the main air supply outlet (534) to cease and/or prevent operation of the milling tool head assembly (210) to machine the linear planar surface on the workpiece.

D9.3.1. The remote control system (500) of paragraph D9.3, wherein the lockout valve (540) is configured to be selectively transitioned between a flow state, in which the pneumatic air flow may flow from the pneumatic air inlet (532) to the main air supply outlet (534), and a lockout state, in which the pneumatic air flow is restricted from reaching the main air supply outlet (534).

D9.4. The remote control system (500) of any of paragraphs D9-D9.3, wherein the pneumatic conditioning unit (530) comprises a flow control valve (542) configured to selectively modulate one or both of a flow rate of the pneumatic air flow and a pressure of the pneumatic air flow to the main air supply outlet (534).

D10. The remote control system (500) of any of paragraphs D-D9.4, when dependent from paragraph D9, further comprising an auxiliary conditioning unit (550) configured to receive the pneumatic air flow from the pneumatic conditioning unit (530) and to supply the pneumatic air flow to the portable machine tool (200) at least partially based upon the user input received by the operator pendant (510).

D10.1. The remote control system (500) of paragraph D10, wherein the auxiliary conditioning unit (550) comprises an operator pendant interface (552) configured to receive the control signal from the operator pendant (510), wherein the control tether (502) is configured to be selectively and operatively coupled to the operator pendant interface (552) to convey the control signal between the operator pendant (510) and the auxiliary conditioning unit (550), optionally from the operator pendant (510) to the auxiliary conditioning unit (550).

D10.2. The remote control system (500) of any of paragraphs D10-D10.1, wherein the auxiliary conditioning unit (550) comprises one or more of:

(i) a main air supply inlet (554) configured to receive the at least a portion of the pneumatic air flow from a/the main air supply outlet (534),

(ii) a chip blower air supply inlet (560) configured to receive a/the portion of the pneumatic air flow from a/the chip blower air supply outlet (536),

(iii) a feed motor air outlet (556) configured to convey at least a portion of the pneumatic air flow to the portable machine tool (200), optionally to a/the motor (216), to translate the milling tool head (338) along the primary tool path,

(iv) a spindle motor air outlet (558) configured to convey at least a portion of the pneumatic air flow to the portable machine tool (200), optionally to a/the motor (216), to rotate the cutting tool spindle (346),

(v) a chip blower air outlet (562) configured to convey at least a portion of the pneumatic air flow to the portable machine tool (200) to facilitate removal of chips produced during operative use of the portable machine tool (200),

(vi) a chip blower valve (564) configured to selectively initiate and cease a flow of the pneumatic air flow from the chip blower air outlet (562), and

(vii) a low pressure dropout outlet (566) configured to convey a portion of the control signal to the pneumatic conditioning unit (530).

D11. The remote control system (500) of any of paragraphs D-D10.2, wherein the remote control system (500) is configured to be transitioned between a running configuration, in which the remote control system (500) operates to direct the pneumatic air flow from a/the pneumatic air inlet to the portable machine tool (200), and a stopped configuration, in which the remote control system (500) operates to restrict the pneumatic air flow from flowing to the portable machine tool (200).

D11.1 The remote control system (500) of paragraph D11, wherein a/the machine start control (512) is configured to receive a/the user input to selectively transition the remote control system (500) from the stopped configuration to the running configuration.

D11.2. The remote control system (500) of any of paragraphs D11-D11.1, wherein a/the machine stop control (514) is configured to receive a/the user input to selectively transition the remote control system (500) from the running configuration to the stopped configuration.

D11.3. The remote control system (500) of any of paragraphs D11-D11.2, wherein the remote control system (500) is configured to automatically transition from the running configuration to the stopped configuration when the supply of the pneumatic air flow to the portable machine tool (200) is interrupted; and wherein the remote control system (500) is configured to transition from the stopped configuration to the running configuration only when both of:

(i) the pneumatic air flow to the portable machine tool (200) is unblocked; and

(ii) a/the machine start control (512) is operated to transition the remote control system (500) from the stopped configuration to the running configuration.

D11.4. The remote control system (500) of any of paragraphs D11-D11.3, wherein a/the pneumatic conditioning unit (530) comprises:

a low pressure dropout inlet (544) configured to receive a portion of the pneumatic air flow, optionally from a/the low pressure dropout outlet (566), and

a low pressure dropout valve (546) configured to restrict the flow of the pneumatic air flow from a/the pneumatic air inlet (532) to a/the main air supply outlet (534) to transition the remote control system (500) to the stopped configuration when a pressure of the pneumatic air flow received at the low pressure dropout inlet (544) falls below a predetermined threshold pressure.

D12. The remote control system (500) of any of paragraphs D-D11.4, further comprising one or more pneumatic conduits (504) configured to convey the pneumatic air flow from the pneumatic conditioning unit (530) to one or both of a/the auxiliary conditioning unit (550) and the portable machine tool (200).

D13. The remote control system (500) of any of paragraphs D-D12, in combination with the portable machine tool (200).

D14. The remote control system (500) of any of paragraphs D-D13, comprised in the portable machine tool (200) of any of paragraphs C-C6.2.

E. A method of machining an annular planar surface and a linear planar surface on a workpiece, the method comprising:

fixedly coupling a machine frame of a portable machine tool to the workpiece;

while the machine frame is fixedly coupled to the workpiece, facing the annular planar surface using a facing tool head assembly by rotating a rotating ring of the portable machine tool relative to the machine frame; and

while the machine frame is fixedly coupled to the workpiece, milling the linear planar surface using a milling tool head assembly.

E1. The method of paragraph E, further comprising:

restricting rotation of the rotating ring relative to the machine frame;

wherein the milling is performed while the rotating ring is restricted from rotating relative to the machine frame.

E1.1. The method of paragraph E1, wherein the restricting comprises locking the rotating ring relative to the machine frame.

E2. The method of any of paragraphs E-E1.1, further comprising:

while the machine frame is fixedly coupled to the workpiece, rotating the rotating ring relative to the machine frame to align the milling tool head assembly relative to the workpiece for milling the linear planar surface using the milling tool head assembly.

E2.1. The method of paragraph E2 when depending from paragraph E1, wherein the rotating is performed prior to the restricting.

E2.2. The method of any of paragraphs E2-E2.1, wherein the linear planar surface is a first linear planar surface, and wherein the method further comprises:

while the machine frame is fixedly coupled to the workpiece and after the milling the first linear planar surface using the milling tool head assembly, rotating the rotating ring relative to the machine frame to align the milling tool head assembly relative to the workpiece for milling a second linear planar surface on the workpiece using the milling tool head assembly, and then milling the second linear planar surface using the milling tool head assembly.

E2.2.1. The method of paragraph E2.1, further comprising:

while the machine frame is fixedly coupled to the workpiece, after the rotating the rotating ring relative to the machine frame to align the milling tool head assembly relative to the workpiece for milling the second linear planar surface on the workpiece using the milling tool head assembly, and prior to the milling the second linear planar surface using the milling tool head assembly, restricting rotation of the rotating ring relative to the machine frame.

E2.3. The method of any of paragraphs E2-E2.2.1, wherein the linear planar surface is a/the first linear planar surface, and wherein the method further comprises:

while the machine frame is fixedly coupled to the workpiece and after the milling the first linear planar surface using the milling tool head assembly, translating the milling tool head assembly relative to the rotating ring to align the milling tool head assembly relative to the workpiece for milling a/the second linear planar surface on the workpiece using the milling tool head assembly, and then milling the second linear planar surface using the milling tool head assembly.

E2.3.1. The method of paragraph E2.3, wherein the translating the milling tool head assembly relative to the rotating ring comprises translating a bridge of the portable machine tool relative to the rotating ring.

E3. The method of any of paragraphs E-E2.3.1, further comprising:

while the machine frame is fixedly coupled to the workpiece, milling a chamfer between the annular planar surface and the linear planar surface or between a/the first linear planar surface and a/the second linear planar surface.

E3.1. The method of paragraph E3, further comprising:

prior to the milling the chamfer, adjusting the milling tool head assembly to adjust an angle of a secondary tool path of the milling tool head assembly relative to the workpiece.

E4. The method of any of paragraphs E-E3.1, wherein the facing the annular planar surface using the facing tool head assembly is performed prior to the milling the linear planar surface using the milling tool head assembly.

E4.1. The method of paragraph D4, further comprising:

while the machine frame is fixedly coupled to the workpiece and after the facing the annular planar surface using the facing tool head assembly, removing the facing tool head assembly from the rotating ring; and

while the machine frame is fixedly coupled to the workpiece, after the removing the facing tool head assembly from the rotating ring, and prior to the milling the linear planar surface using the milling tool head assembly, mounting the milling tool head assembly to the rotating ring.

E5. The method of any of paragraphs E-E3.1, wherein the milling the linear planar surface using the milling tool head assembly is performed prior to the facing the annular planar surface using the facing tool head assembly.

E5.1. The method of paragraph E5, further comprising:

while the machine frame is fixedly coupled to the workpiece and after the milling the linear planar surface using the milling tool head assembly, removing the milling tool head assembly from the rotating ring; and

while the machine frame is fixedly coupled to the workpiece, after the removing the milling tool head assembly from the rotating ring, and prior to the facing the annular planar surface using the facing tool head assembly, mounting the facing tool head assembly to the rotating ring.

E6. The method of any of paragraphs E-E5.1, wherein the portable machine tool is a flange facer, and wherein the method further comprises:

mounting a milling machine to the rotating ring, wherein the milling machine comprises the milling tool head assembly.

E6.1. The method of paragraph E6, when depending from paragraph E4.1 or E5.1, wherein the removing the facing tool head assembly from the rotating ring comprises removing the facing tool head assembly and a/the bridge of the flange facer from the rotating ring.

E6.2. The method of any of paragraphs E6-E6.1, wherein the milling machine is a gantry milling machine.

E6.3. The method of any of paragraphs E6-E6.2, wherein the flange facer is an outer-diameter (OD) mount flange facer.

E7. The method of any of paragraphs E-E5.1, further comprising:

prior to the facing the annular planar surface using the facing tool head assembly, mounting the facing tool head assembly to a/the bridge of the portable machine tool; and

prior to the milling the linear planar surface using the milling tool head assembly, mounting the milling tool head assembly to the bridge.

E7.1. The method of paragraph E7, further comprising:

prior to the mounting the milling tool head assembly to the bridge, removing the facing tool head assembly from the bridge.

E7.2. The method of any of paragraphs E7-E7.1, further comprising:

prior to the mounting the facing tool head assembly to the bridge, removing the milling tool head assembly from the bridge.

E8. The method of any of paragraphs E-E7.2, wherein the workpiece is a tube sheet of a shell-and-tube heat exchanger, wherein the annular planar surface is an annular circular gasket surface, and wherein the linear planar surface is a linear groove.

F. A method, comprising:

using a machine frame of a flange facer and a rotating ring of the flange facer to mount a milling machine to a workpiece; and

machining the workpiece using the milling machine when it is coupled to the rotating ring of the flange facer.

F1. The method of paragraph F, further comprising the subject matter of any of paragraphs E-E8.

G. A method comprising machining each of an annular planar surface and a linear planar surface of a workpiece using a combination flange facer and milling machine.

G1. The method of paragraph G, further comprising the subject matter of any of paragraphs E-E8.

H. A method of retrofitting a flange facer, the method comprising:

creating a mounting structure on a rotating ring of the flange facer, wherein the mounting structure is configured to provide for operative mounting of a milling machine to the rotating ring of the flange facer.

H1.1. The method of paragraph H, wherein the mounting structure comprises holes in the rotating ring, and wherein the holes in the rotating ring are configured to align with holes in the milling machine for receipt of fasteners to operatively mount the milling machine to the rotating ring.

I. A method, comprising:

performing the method of any of paragraphs H-H1.1; and performing the method of any of paragraphs E6-E6.3, wherein the flange facer and the milling machine of paragraph H are the flange facer and the milling machine of paragraph E6.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, the terms “selective” and “selectively,” when modifying an action, movement, configuration, or other activity of one or more components or characteristics of an apparatus, mean that the specific action, movement, configuration, or other activity is a direct or indirect result of one or more dynamic processes, as described herein. The terms “selective” and “selectively” thus may characterize an activity that is a direct or indirect result of user manipulation of an aspect of, or one or more components of, the apparatus, or may characterize a process that occurs automatically, such as via the mechanisms disclosed herein.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); and in yet another example, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); and in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “at least substantially,” when modifying a degree or relationship, comprises not only the recited “substantial” degree or relationship, but also the full extent of the recited degree or relationship. A substantial amount of a recited degree or relationship may comprise at least 75% of the recited degree or relationship. For example, a first direction that is at least substantially parallel to a second direction comprises a first direction that is within an angular deviation of 22.5° relative to the second direction and also comprises a first direction that is identical to the second direction.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order, concurrently, and/or repeatedly. It is also within the scope of the present disclosure that the blocks, or steps, may be implemented as logics, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

The various disclosed elements of apparatuses and steps of methods disclosed herein are not required to all apparatuses and methods according to the present disclosure, and the present disclosure comprises all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions comprises all novel and non-obvious combinations and subcombinations of the various elements, features, functions and/or properties disclosed herein. Similarly, where the claims recite “a” or “a first” element or the equivalent thereof, such claims should be understood to comprise incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as comprised within the subject matter of the inventions of the present disclosure.

1. A milling tool head assembly, comprising:
a milling tool head carriage, and
a milling tool head,
wherein the milling tool head comprises:
a milling tool head base that is pivotally coupled to the milling tool head carriage, and
a milling tool carrier that is configured to be operatively coupled to a cutting tool that is configured to machine a workpiece,
wherein the milling tool carrier is configured to travel along a primary tool path relative to the workpiece, and wherein the milling tool carrier is slidingly coupled to the milling tool head base to define a secondary tool path of the milling tool carrier relative to the workpiece.

2. The milling tool head assembly of claim 1, further comprising a cutting tool spindle that extends through the milling tool carrier along a Z-axis, wherein the cutting tool spindle is configured to one or both of support the cutting tool relative to the workpiece and rotate the cutting tool relative to the workpiece, and optionally wherein the cutting tool spindle is configured to be selectively adjusted relative to the milling tool carrier along the Z-axis.

3. The milling tool head assembly of claim 2, further comprising a spindle adjustment input shaft that is configured to receive a rotary input to selectively translate the cutting tool spindle relative to the milling tool carrier along the Z-axis.

4. The milling tool head assembly of claim 1, wherein the milling tool carrier is slidingly coupled to the milling tool head base via a sliding joint, wherein the sliding joint is configured to selectively permit the milling tool carrier to translate relative to the milling tool head base along the secondary tool path.

5. The milling tool head assembly of claim 1, further comprising a tool head drive input shaft that is configured to receive a rotary input to selectively translate the milling tool carrier relative to the milling tool head base along the secondary tool path.

6. The milling tool head assembly of claim 1, further comprising a milling tool carrier lock mechanism that is configured to selectively engage each of the milling tool carrier and the milling tool head base to selectively restrict the milling tool carrier from translating relative to the milling tool head base.

7. The milling tool head assembly of claim 1, further comprising a secondary tool path angle adjustment mechanism that is configured to selectively pivot the milling tool head base relative to the milling tool head carriage to at least partially define an orientation of the secondary tool path.

8. The milling tool head assembly of claim 1, wherein the primary tool path extends along a direction parallel to an X-axis wherein the secondary tool path extends along an X2-axis, and wherein the milling tool head base is configured to pivot relative to the milling tool head carriage about a milling tool head pivot axis to selectively adjust an angle between the X2-axis and the X-axis.

9. The milling tool head assembly of claim 8, wherein the milling tool head carriage is configured to selectively adjust an orientation of the milling tool carrier relative to one or more of at least a portion of the milling tool head carriage, the X-axis, and the workpiece, and wherein the milling tool head carriage is configured to selectively pivot the milling tool head relative to one or more of at least a portion of the milling tool head carriage, the X-axis, and the workpiece about one or more of:
(i) an axis that is at least substantially parallel to the X-axis,
(ii) an axis that is at least substantially parallel to a Z-axis that is perpendicular to the X-axis,
(iii) an axis that is at least substantially parallel to a Y-axis that is perpendicular to each of the X-axis and the Z-axis, and
(iv) an axis that is at least substantially parallel to the milling tool head pivot axis.

10. The milling tool head assembly of claim 9, wherein the milling tool head carriage is configured to be operatively coupled to a track of a machine tool and to translate along the track to translate the milling tool head along the track, wherein the track defines the primary tool path, wherein the machine tool comprises a carriage mount that is operatively coupled to the track, wherein the milling tool head carriage comprises a carriage base that is configured to be adjustably and operatively coupled to the carriage mount, wherein the milling tool head carriage comprises one or more carriage fasteners and one or more carriage adjustment mechanisms, wherein the carriage base is configured to be operatively coupled to the carriage mount at least partially via the one or more carriage fasteners, wherein the one or more carriage fasteners are configured to selectively and operatively retain the carriage base in an at least substantially fixed orientation relative to the carriage mount during operative use of the milling tool head assembly, and wherein the one or more carriage adjustment mechanisms are configured to engage each of the carriage mount and the carriage base to at least partially define the orientation of the carriage base relative to the carriage mount.

11. The milling tool head assembly of claim 10, wherein the one or more carriage adjustment mechanisms are configured to adjust the orientation of the carriage base relative to the carriage mount while the one or more carriage fasteners do not operatively retain the carriage base in the at least substantially fixed orientation relative to the carriage mount.

12. A portable machine tool, comprising:
a machine frame configured to be fixedly coupled to a workpiece to operatively support the portable machine tool on the workpiece;
a rotating ring that is rotatingly coupled to the machine frame;
a bridge coupled to the rotating ring;
a facing tool head assembly configured to be selectively coupled to and decoupled from the bridge, wherein the rotating ring is configured to be selectively rotated relative to the machine frame to rotate the facing tool head assembly to operatively machine an annular planar surface on the workpiece when the facing tool head assembly is coupled to the bridge; and
the milling tool head assembly of claim 1 configured to be selectively coupled to and decoupled from the bridge, wherein the bridge is configured to selectively translate the milling tool head assembly along the bridge to operatively machine a linear planar surface on the workpiece when the milling tool head assembly is coupled to the bridge.

13. The portable machine tool of claim 12, wherein the rotating ring comprises a linear bed, and wherein the bridge is configured to be selectively translated along a length of the linear bed.

14. The portable machine tool of claim 13, wherein the linear bed comprises two spaced-apart bed portions, and wherein the bridge extends between the two spaced-apart bed portions in a gantry configuration.

15. The portable machine tool of claim 12, further comprising a remote control system that comprises:
an operator pendant configured to receive a user input from a human user and to generate a control signal for remote operation of the portable machine tool; and
a control tether extending from the operator pendant to convey the control signal to another component of the remote control system.

16. The portable machine tool of claim 15, wherein the remote control system is configured to permit the user to selectively and remotely one or more of:
(i) initiate and cease, via the control signal, translation of the milling tool head along the primary tool path,
(ii) command the milling tool head, via the control signal, to translate along the primary tool path along either of a first direction or a second direction that is opposite the first direction, and
(iii) vary, via the control signal, a speed at which the milling tool head travels along the primary tool path.

17. The portable machine tool of claim 15, wherein the milling tool head assembly comprises a cutting tool spindle configured to support the cutting tool relative to the workpiece and to rotate the cutting tool relative to the workpiece, and wherein the remote control system is configured to permit the user to one or both of:
(i) selectively and remotely initiate and cease, via the control signal, rotation of the cutting tool spindle, and
(ii) selectively and remotely vary, via the control signal, a rotational speed at which the cutting tool spindle rotates the cutting tool.

18. The portable machine tool of claim 15, wherein the remote control system further comprises a pneumatic conditioning unit configured to receive and condition a pneumatic air source, wherein the pneumatic conditioning unit comprises:
a pneumatic air inlet configured to receive a pneumatic air flow, and
a main air supply outlet configured to supply at least a portion of the pneumatic air flow to one or both of another component of the remote control system and the portable machine tool, and wherein the control signal comprises at least a portion of the pneumatic air flow.

19. The portable machine tool of claim 18, wherein the pneumatic conditioning unit comprises one or both of:
(i) a lockout valve configured to selectively interrupt a flow of pneumatic air from the pneumatic air inlet to the main air supply outlet to cease operation of the milling tool head assembly to machine the linear planar surface on the workpiece, and
(ii) a flow control valve configured to selectively modulate one or both of a flow rate of the pneumatic air flow and a pressure of the pneumatic air flow to the main air supply outlet.

20. The portable machine tool of claim 18, further comprising an auxiliary conditioning unit configured to receive the pneumatic air flow from the pneumatic conditioning unit and to supply the pneumatic air flow to the portable machine tool at least partially based upon the user input received by the operator pendant, wherein the auxiliary conditioning unit comprises an operator pendant interface configured to receive the control signal from the operator pendant, wherein the control tether is configured to be selectively and operatively coupled to the operator pendant interface to convey the control signal between the operator pendant and the auxiliary conditioning unit.

21. The portable machine tool of claim 15, wherein the operator pendant comprises:
a machine start control configured to initiate translation of the milling tool head along the primary tool path, and
a machine stop control configured to cease translation of the milling tool head along the primary tool path;
wherein the remote control system is configured to be transitioned between a running configuration, in which the remote control system operates to direct the pneumatic air flow from a pneumatic air inlet to the portable machine tool, and a stopped configuration, in which the remote control system operates to restrict the pneumatic air flow from flowing to the portable machine tool, wherein the remote control system is configured to automatically transition from the running configuration to the stopped configuration when the supply of the pneumatic air flow to the portable machine tool is interrupted; and wherein the remote control system is configured to transition from the stopped configuration to the running configuration only when both of:
(i) the pneumatic air flow to the portable machine tool is unblocked; and
(ii) the machine start control is operated to transition the remote control system from the stopped configuration to the running configuration.

22. A remote control system for a portable machine tool that comprises a machine frame, a rotating ring that is rotatingly coupled to the machine frame, and a milling tool head assembly with a milling tool head configured to convey a cutting tool along a primary tool path to machine a linear planar surface on a workpiece, the remote control system comprising:
an operator pendant configured to receive a user input from a human user and to generate a control signal for remote operation of the portable machine tool,
a control tether extending from the operator pendant to convey the control signal to another component of the remote control system,
a pneumatic conditioning unit configured to receive and condition a pneumatic air source, and
an auxiliary conditioning unit configured to receive the pneumatic air flow from the pneumatic conditioning unit and to supply the pneumatic air flow to the portable machine tool at least partially based upon the user input received by the operator pendant,
wherein the pneumatic conditioning unit comprises:
a pneumatic air inlet configured to receive a pneumatic air flow, and
a main air supply outlet configured to supply at least a portion of the pneumatic air flow to one or both of another component of the remote control system and the portable machine tool, wherein the control signal comprises at least a portion of the pneumatic air flow.

23. The remote control system of claim 22, wherein the operator pendant comprises:
a machine start control configured to initiate translation of the milling tool head along the primary tool path, and
a machine stop control configured to cease translation of the milling tool head along the primary tool path;
wherein the remote control system is configured to be transitioned between a running configuration, in which the remote control system operates to direct the pneumatic air flow from the pneumatic air inlet to the portable machine tool, and a stopped configuration, in which the remote control system operates to restrict the pneumatic air flow from flowing to the portable machine tool, wherein the remote control system is configured to automatically transition from the running configuration to the stopped configuration when the supply of the pneumatic air flow to the portable machine tool is interrupted; and wherein the remote control system is configured to transition from the stopped configuration to the running configuration only when both of:
(i) the pneumatic air flow to the portable machine tool is unblocked; and
(ii) the machine start control is operated to transition the remote control system from the stopped configuration to the running configuration.
